(19) United States
(12) Patent Application Publication
(10) Pub. No.: US 2019/0026459 A1
(43) Pub. Date: Jan. 24, 2019

(54) METHODS AND SYSTEMS TO ANALYZE EVENT SOURCES WITH EXTRACTED PROPERTIES, DETECT ANOMALIES, AND GENERATE RECOMMENDATIONS TO CORRECT ANOMALIES

(71) Applicant: VMware, Inc., Palo Alto, CA (US)

(72) Inventors: Ashot Nshan Harutyunyan, Yerevan (AM); Arnak Poghosyan, Yerevan (AM); Nara Movses Grigoryan, Yerevan (AM); Vardan Movsisyan, Yerevan (AM)

(73) Assignee: VMware, Inc., Palo Alto, CA (US)

(21) Appl. No.: 15/653,269

(22) Filed: Jul. 18, 2017

(51) Int. Cl. G06F 21/50; H04L 12/26; H04L 29/06

(52) U.S. Cl. CPC G06F 21/50; H04L 41/142; H04L 63/1425; H04L 43/16

(57) ABSTRACT

Methods and systems are directed to automatically analyzing the behavior of event sources, detecting anomalies in the behavior of event sources, and generating recommendations to correct the detected anomalies. An event source can be an application program, an operating system, a virtual machine, a container, or any other source of event messages in a computer system. Method quantify the event messages generated over time to form property time series data, which is metadata regarding the event messages generated by the event source. Methods compute a threshold from the property time series data. Methods detect abnormal states of the event source when property data points of the property time series data violate the threshold. A systems administrator may be notified by a property digression alert displayed on a system console. Methods also generate a recommendation to correct the anomalous behavior and optimize performance of the event source.

### TECHNICAL FIELD

The present disclosure is directed to analyzing event sources and detecting anomalies in the behavior of event sources from event messages.

### BACKGROUND

Electronic computing has evolved from primitive, vacuum-tube-based computer systems, initially developed during the 1940s, to modern electronic computing systems in which large numbers of multi-processor computer systems, such as server computers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies.

In modern computing systems, individual computers, subsystems, and components generally output large volumes of status, informational, and error messages that are collectively referred to, in the current document, as “event messages.” In large, distributed computing systems, terabytes of event messages may be generated each day. The event messages are sent to a log management server that records the event messages in event logs that are in turn stored as files in data-storage appliances. Log management servers are typically used to analyze the types of events recorded in the event messages, but log management servers currently lack the ability to detect anomalous behavior of an event source from the many thousands, if not millions, of event messages generated by the event source. System administrators seek methods and systems that automatically detect anomalous states of event sources based on the event messages generated by the event source.

### SUMMARY

Methods and systems are directed to automatically analyzing the behavior of event sources, detecting anomalies in the behavior of event sources, and generating recommendations to correct the detected anomalies. An event source can be an application program, an operating system, a virtual machine, a container, or any other source of event messages in a computer system. The methods are stored in one or more data-storage devices and executed using one or more processors of a management server computer. Method quantify the event messages generated over time to form property time series data, which is metadata regarding the event messages generated by the event source. For example, the property time series data may represent the volume or variety of event messages generated in separate time intervals over time. Method compute a threshold from the property time series data. The threshold is a normalcy bound for normal operation of the event source. Methods detect abnormal states of the event source when property data points of the property time series data violate the threshold. An abnormal state indicates anomalous behavior by the event source. A systems administrator may be notified by a property digression alert displayed on a system console. The property digression alert indicates anomalous behavior of the event source. Methods also generate a recommendation to correct the anomalous behavior and optimize performance of the event source.

### DESCRIPTION OF THE DRAWINGS

FIG. 1 shows a general architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing the containers on a VM.

FIG. 13 shows an example of logging event messages in event logs.

FIG. 14 shows an example of a source code with log write instructions.

FIG. 15 shows an example of a log write instruction.

FIG. 16 shows an example of an event message generated by a log write instruction.

FIG. 17 shows a small, eight-entry portion of an event log.

FIG. 18 shows an example of event-type analysis performed on the event message shown in FIG. 16.

FIG. 19 shows quantification of event messages generated by an event source 1902.

FIGS. 20A-20C show three examples of velocity, acceleration, and variety time series data, respectively, for the event source 1902 shown in FIG. 19.

FIGS. 21A-21B show example plots of non-trendy and trendy property time series data, respectively.

FIGS. 22A-22B show example plots of non-trendy and trendy periodic property time series data, respectively.

FIGS. 23A-23B show upper and lower bounds for the non-trendy and trendy property time series data shown in FIGS. 21A-21B, respectively.

FIGS. 24A-24B show upper and lower bounds for the non-trendy and trendy property time series data shown in FIGS. 22A-22B, respectively.

FIGS. 25A-25B show examples of upper and lower threshold violations of property time series data.

FIG. 26 shows an example of identifying alerts of resources that occur within a property alert time window centered at the time of a property digression alert.

FIG. 27 shows a plot of historical property, CPU usage, and memory usage time series data.

FIG. 28 shows an event-type logs determine from event messages of an event log.

FIG. 29 shows a plot of entropies computed for distributions of event types of event messages generated by an event source.

FIG. 30 shows an example plot of volume versus variety time series data points.

FIG. 31 shows a control-flow diagram of a method to detect anomalies of an event source.

FIG. 32 shows a control-flow diagram of the routine “detect anomalous behavior of the event source” called in FIG. 31.

FIG. 33 shows a control-flow diagram of the routine “detect abnormal state of event source and correlation with resources” called in FIG. 32.

FIG. 34 shows a control-flow diagram of the routine “detect historical abnormal states of event source and correlation with resources” called in FIG. 33.

FIG. 35 shows a control-flow diagram of the routine “detect changes in entropy of distributions of event messages” called in FIG. 32.

FIG. 36 shows a control-flow diagram of the routine “detect anomalous behavior conflicts between two or more properties” called in FIG. 31.

### DETAILED DESCRIPTION

This disclosure presents computational methods and systems to analyze the behavior of event sources, detect anomalies in the behavior of the event source, and generate recommendations to correct the detected anomalies. In a first subsection, computer hardware, complex computational systems, and virtualization are described. Containers and containers supported by virtualization layers are described in a second subsection. Logging event messages in event logs is described in a third subsection. Methods to analyze and detect anomalies of event sources are described below in a fourth subsection.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

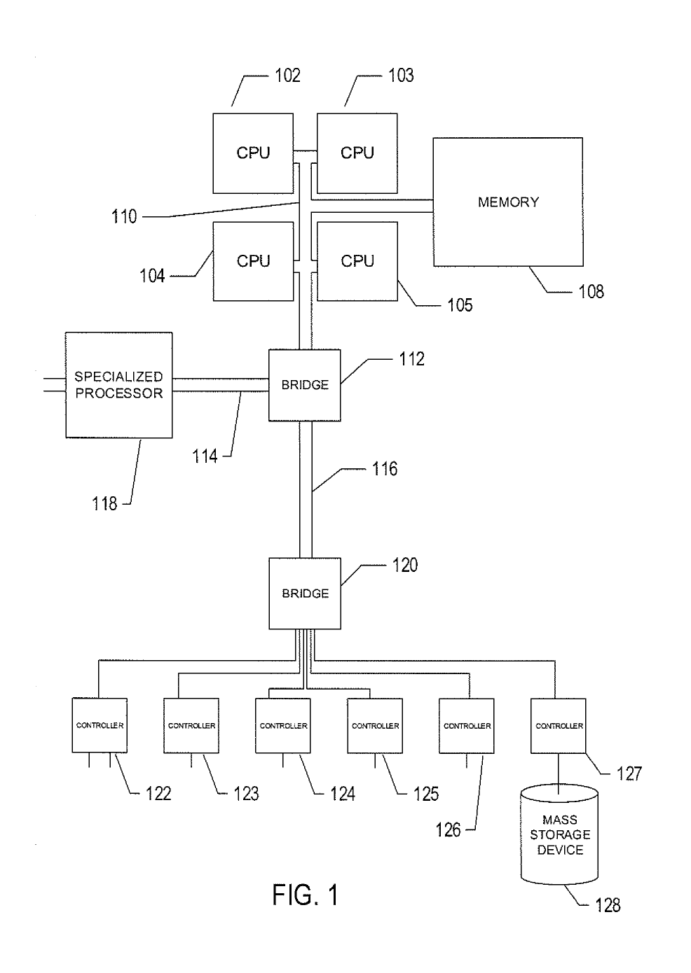

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

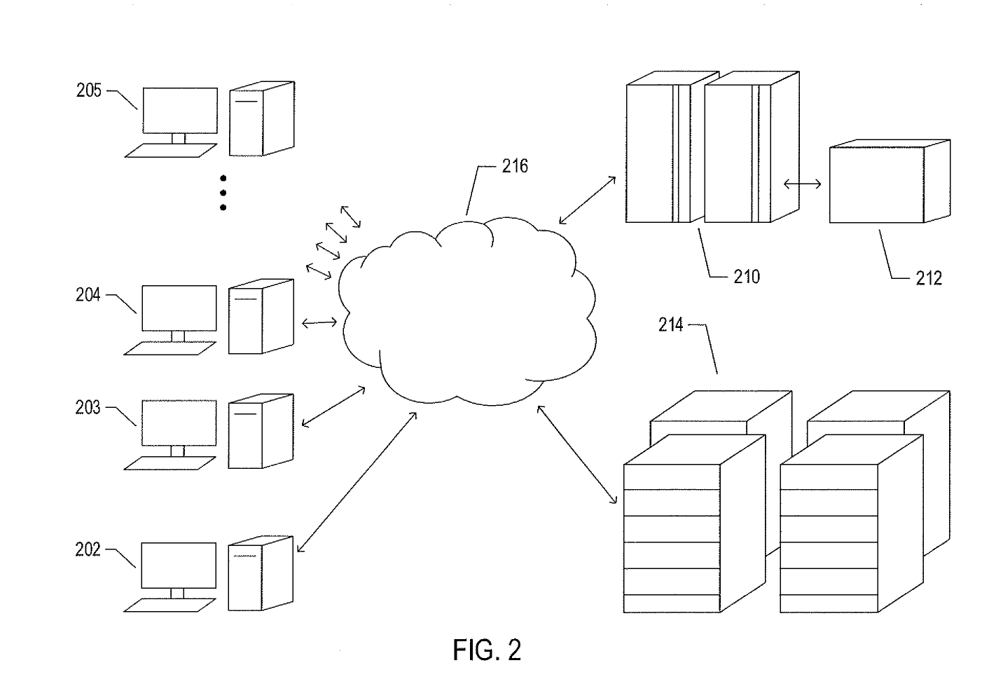

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

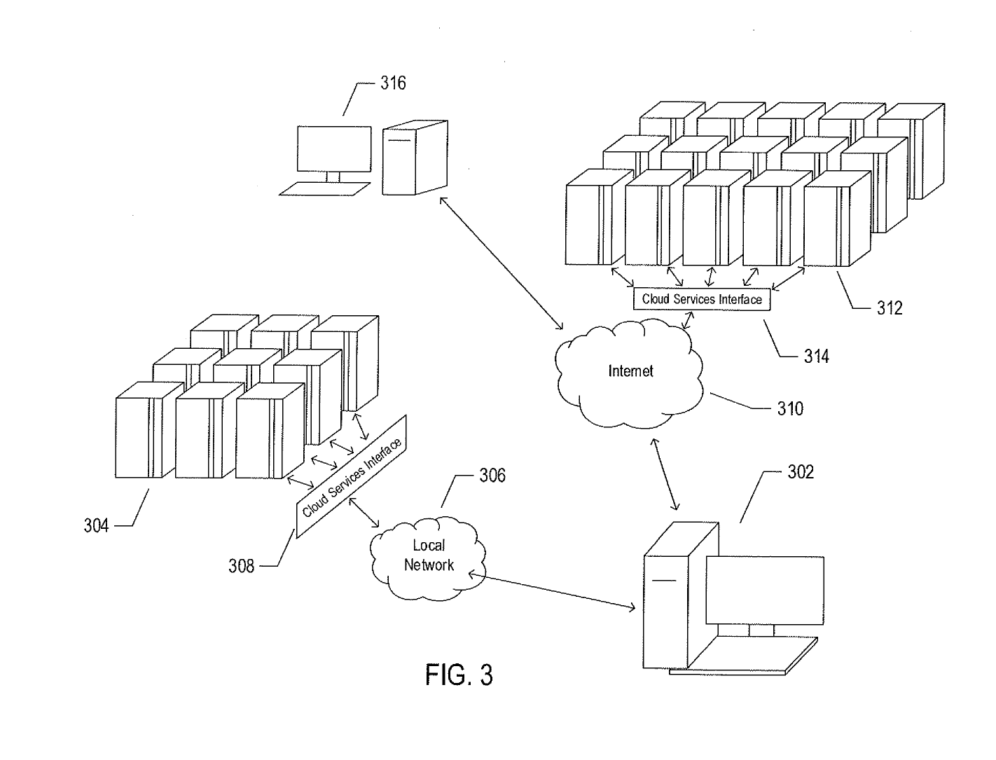

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

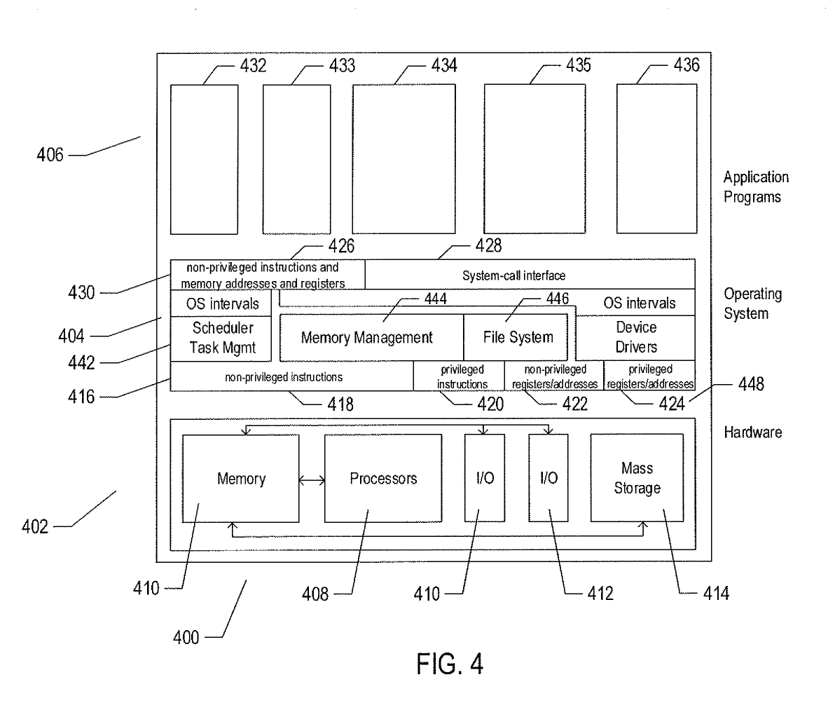

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

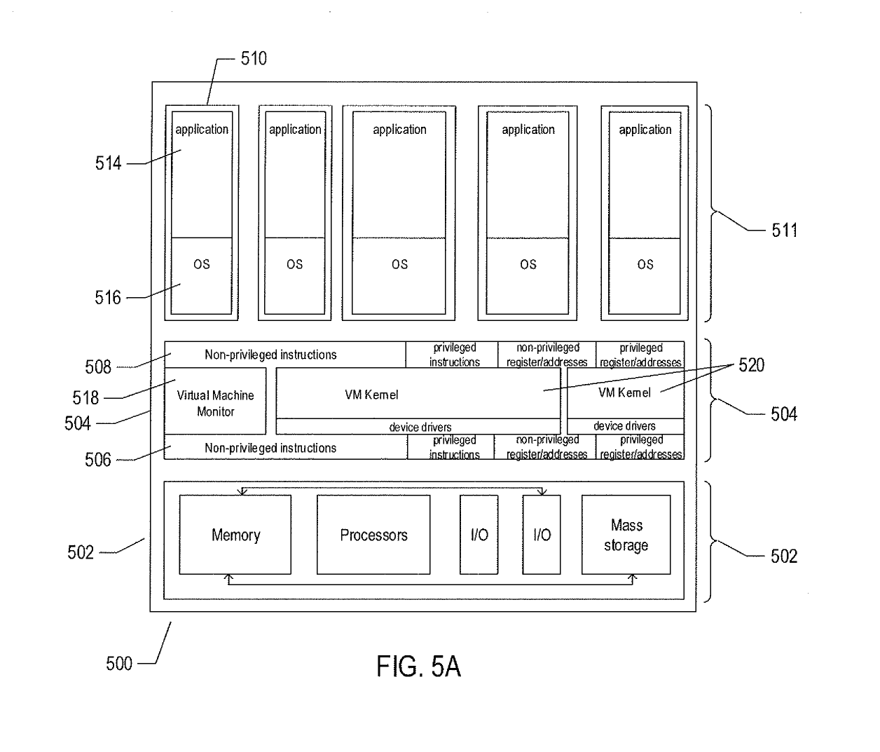

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to a number of VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

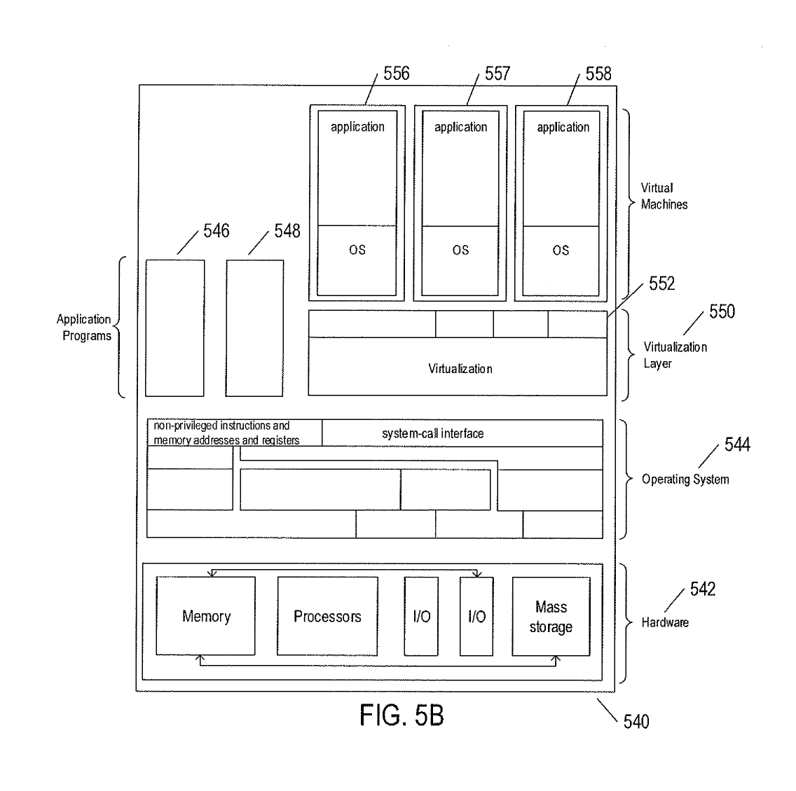

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or entirely eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

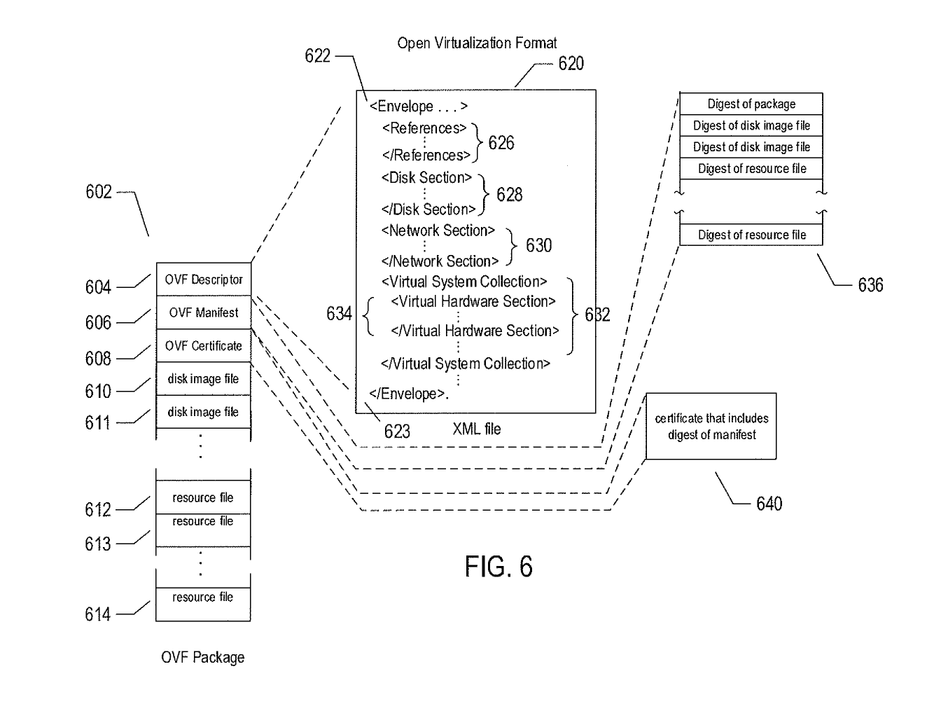

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

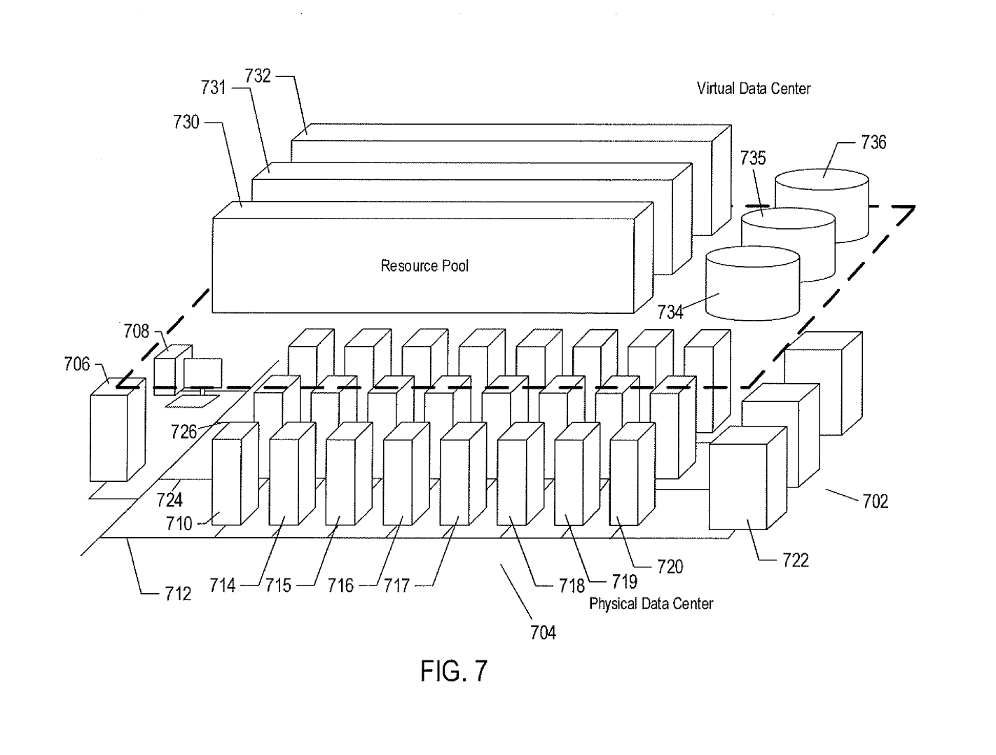

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808, and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“APP”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

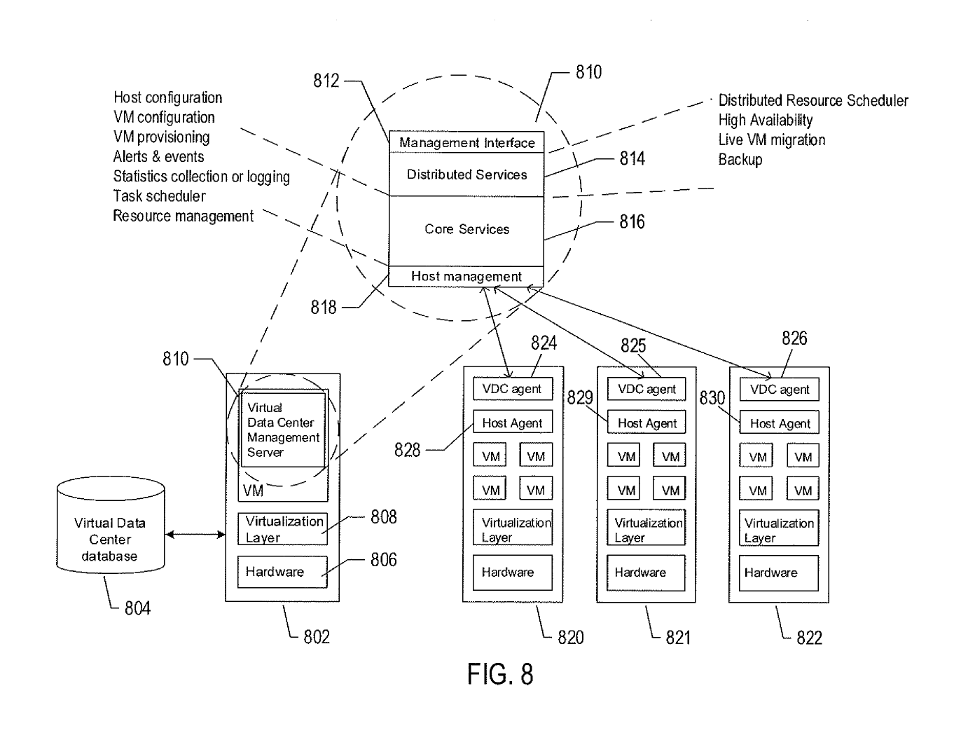

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

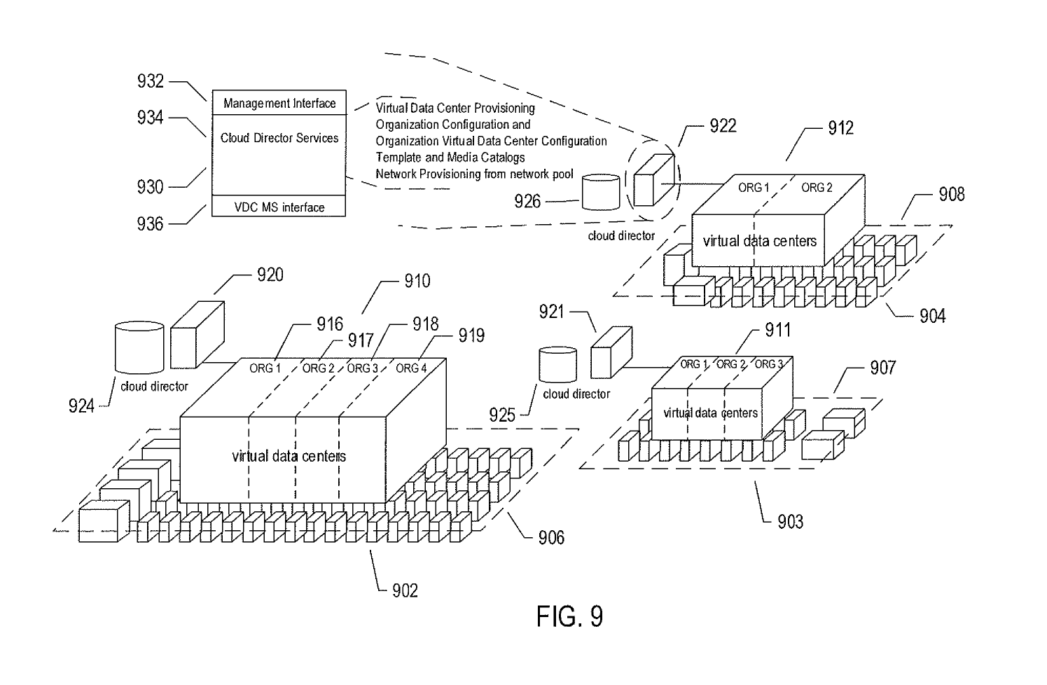

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Containers and Containers Supported by Virtualization Layers

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files not included the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

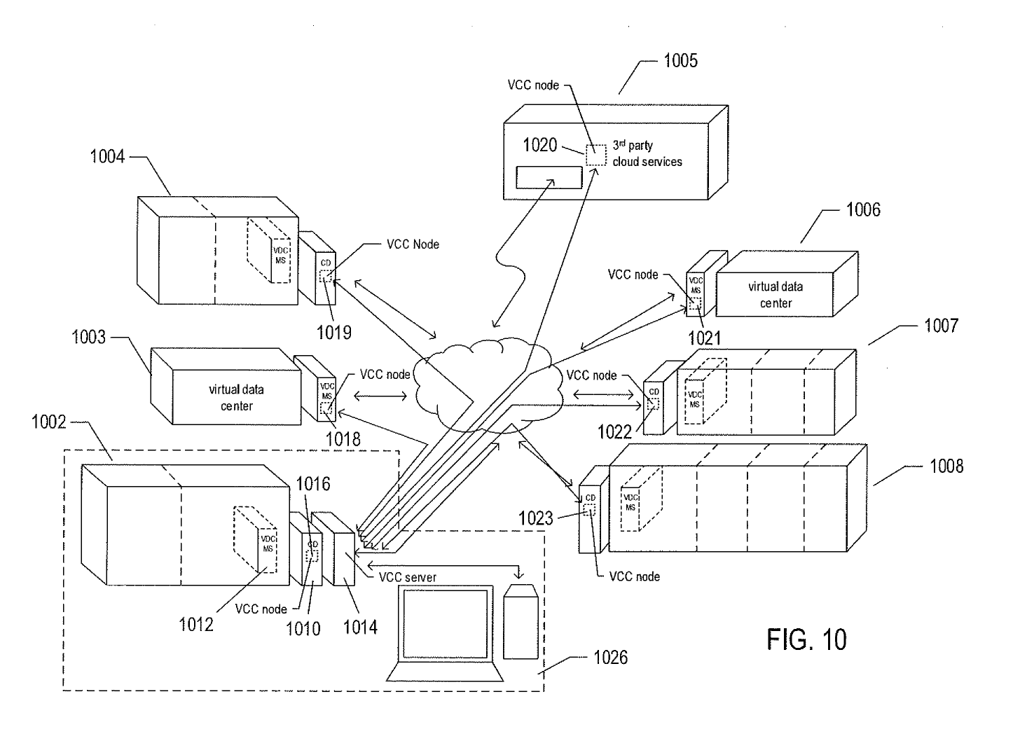

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

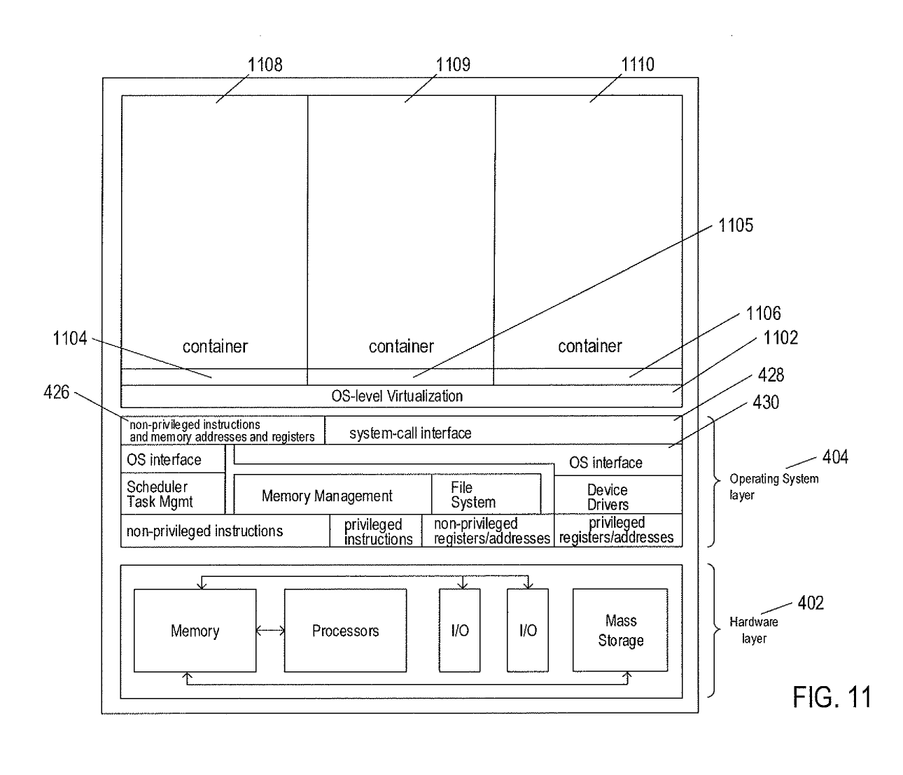

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Logging Event Messages in Event Logs and Determining Event Types

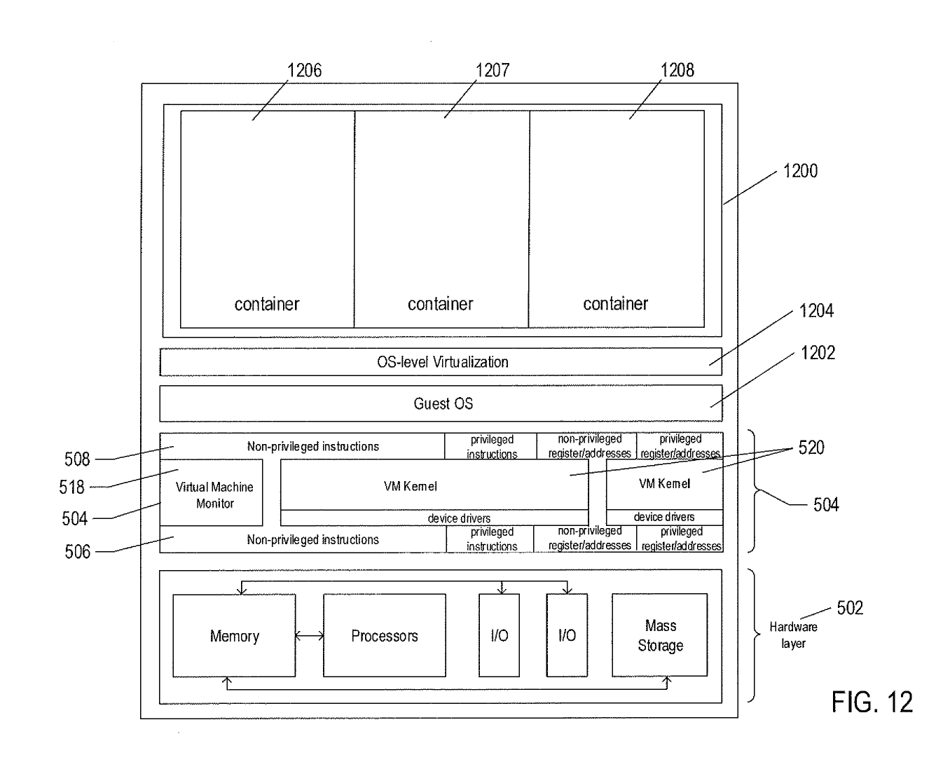

FIG. 13 shows an example of logging event messages in event logs.

In FIG. 13, a number of computer systems 1302-1306 within a distributed computing system are linked together by an electronic communications medium 1308 and additionally linked through a communications bridge/router 1310 to an administration computer system 1312 that includes an administrative console 1314. One or more of the computer systems 1302-1306 may run a log monitoring agent that collects and forwards event messages to a log management server that runs on the administration console 1314. As indicated by curved arrows, such as curved arrow 1316, multiple components within each of the discrete computer systems 1302-1306 as well as the communications bridge/router 1310 generate event messages that are forwarded to the log management server. Event messages may be generated by any event source. Event sources may be, but are not limited to, application programs, operating systems, VMs, guest operating systems, containers, network devices, machine codes, event channels, and other computer programs or processes running on the computer systems 1302-1306, the bridge/router 1310 and any other components of the distributed computing system. Event messages may be collected at various hierarchical levels within a discrete computer system and then forwarded to the log management server in the administration computer 1312. For example, a log monitoring agent may collect and forward the event messages at various hierarchical levels. The log management server in the administration computer 1312 collects and stores the received event messages in a data-storage device or appliance 1318 as event logs 1320-1324. Rectangles, such as rectangle 1326, represent individual event messages. For example, event log 1320 may comprise a list of event messages generated within the computer system 1302. Each log monitoring agent has an agent monitoring configuration that includes a log path and a log parser. The log path specifies a unique file system path in terms of a directory tree hierarchy that identifies the storage location of an event log associated with the event source on the administrative console 1314 or the data-storage device or appliance 1318. The log monitoring agent receives specific file and event channel log paths to monitor event logs and the log parser includes log parsing rules to extract and format lines of event message into event message fields. The log monitoring agent then sends the constructed structured event messages to the log management server. The administrative console 1314 and computer systems 1302-1306 can function without log management agents and a log management server, but with less precision and certainty.

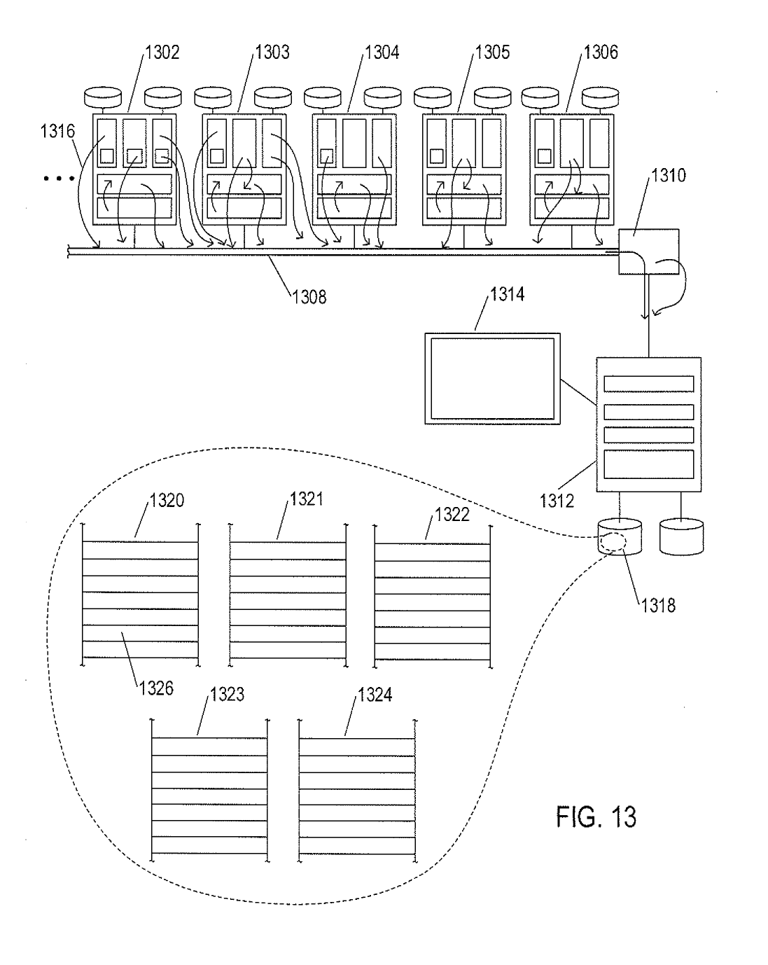

FIG. 14 shows an example of a source code 1402 of an application program, an operating system, a VM, a guest operating system, or any other computer program or machine code. The source code 1402 is just one example of an event source that generates event messages. Rectangles, such as rectangle 1404, represent a definition, a comment, a statement, or a computer instruction that expresses some action to be executed by a computer. The source code 1402 includes log write instructions that generate event messages when certain events predetermined by the developer occur during execution of the source code 1402. For example, source code 1402 includes an example log write instruction 1406 that when executed generates an “event message 1” represented by rectangle 1408, and a second example log write instruction 1410 that when executed generates “event message 2” represented by rectangle 1412. In the example of FIG. 14, the log write instruction 1408 is embedded within a set of computer instructions that are repeatedly executed in a loop 1414. As shown in FIG. 14, the same event message 1 is repeatedly generated 1416. The same type of log write instructions may also be located in different places throughout the source code, which in turns creates repeats of essentially the same type of event message in the event log.

In FIG. 14, the notation “log.write( )” is a general representation of a log write instruction. In practice, the form of the log write instruction varies for different programming languages. In general, event messages are relatively cryptic, including generally only one or two natural-language words and/or phrases as well as various types of text strings that represent file names, path names, and, perhaps various alphanumeric parameters. In practice, a log write instruction may also include the name of the source of the event message (e.g., name of the application program or operating system and version) and the name of the event log to which the event message is written. Log write instructions may be written in a source code by the developer of an application program or operating system in order to record events that occur while an operating system or application program is running. For example, a developer may include log write instructions that are executed when certain events occur, such as failures, logins, or errors.

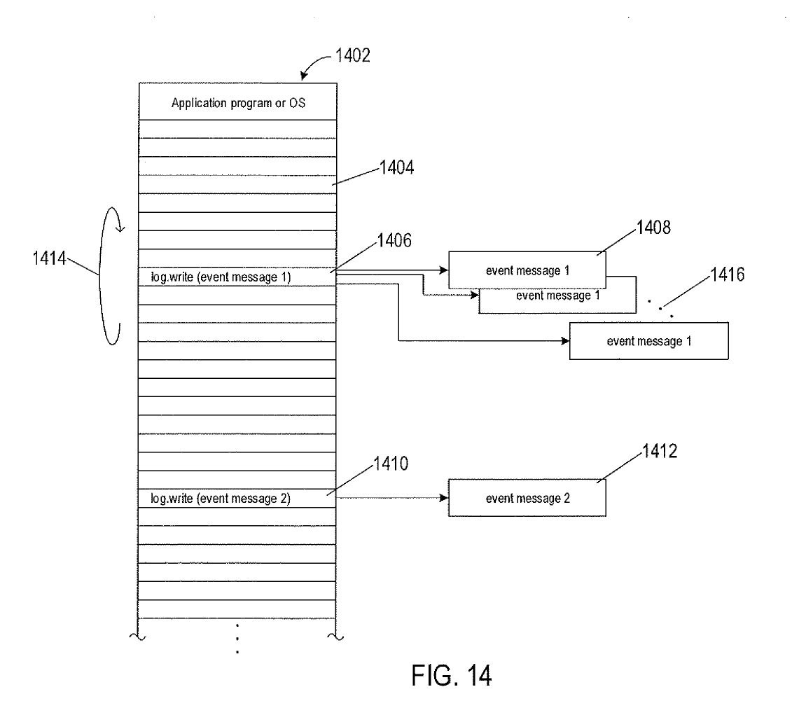

FIG. 15 shows an example of a log write instruction 1502. In the example of FIG. 15, the log write instruction 1502 includes arguments identified with “$.” For example, the log write instruction 1502 includes a time-stamp argument 1504, a thread number argument 1505, and an internet protocol (“IP”) address argument 1506. The example log write instruction 1502 also includes text strings and natural-language words and phrases that identify the type of event that triggered the log write instruction, such as “Repair session” 1508. The text strings between brackets “[ ]” represent file-system paths, such as path 1510. When the log write instruction 1502 is executed, parameters are assigned to the arguments and the text strings and natural-language words and phrases are stored as an event message in an event log.

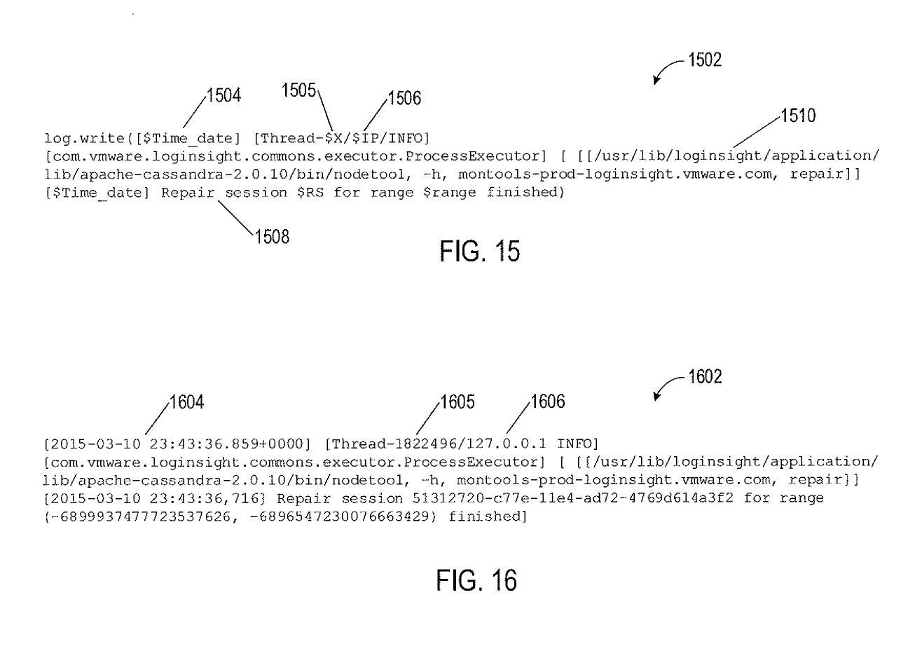

FIG. 16 shows an example of an event message 1602 generated by the log write instruction 1502. The arguments of the log write instruction 1502 may be assigned numerical parameters that are recorded in the event message 1602 at the time the event message is written to the event log. For example, the time stamp 1504, thread 1505, and IP address 1506 of the log write instruction 1502 are assigned corresponding numerical parameters 1604-1606 in the event message 1602. The time stamp 1604, in particular, represents the date and time the event message is generated. The text strings and natural-language words and phrases of the log write instruction 1502 also appear unchanged in the event message 1602 and may be used to identify the type of event that occurred during execution of the application program or operating system.

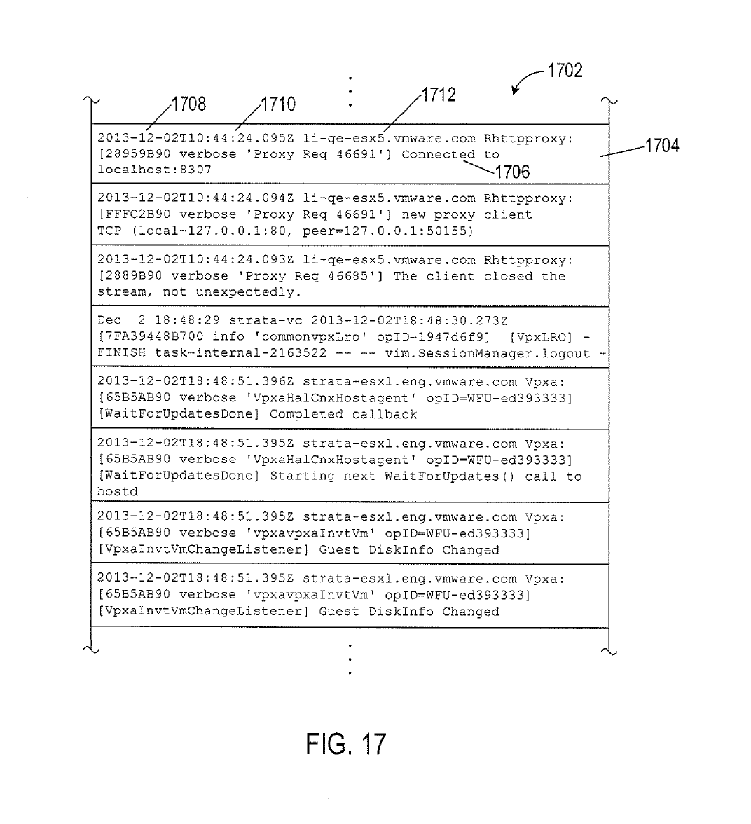

As event messages are received from various event sources, the event messages are stored in the order in which the event messages are received. FIG. 17 shows a small, eight-entry portion of an event log 1702. In FIG. 17, each rectangular cell, such as rectangular cell 1704, of the portion of the event log 1702 represents a single stored event message. For example, event message 1702 includes a short natural-language phrase 1706, date 1708 and time 1710 numerical parameters, as well as, an alphanumeric parameter 1712 that appears to identify a particular host computer.

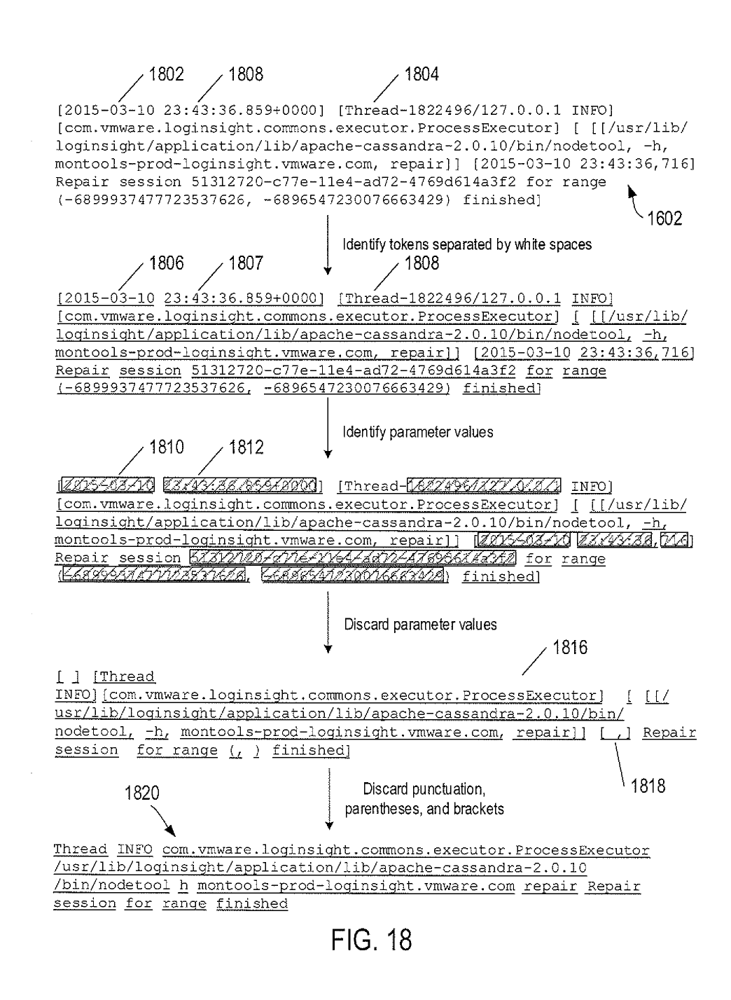

FIG. 18 shows an example of event-type analysis performed on the event message 1602 shown in FIG. 16. The event message 1602 is first tokenized by considering the event message as comprising tokens separated by non-printed characters, referred to as “white space.” In FIG. 18, this initial tokenization of the event message 1602 is illustrated by underlining of the printed or visible characters. For example, the date 1802, time 1803, and thread 1804 at the beginning of the text contents of the event message 1802, following initial tokenization, become a first token 1806, a second token 1807, and a third token 1808, as indicated by underlining. Next, a token-recognition pass is made to recognize any of the initial tokens as various types of parameters. Parameters are tokens or message fields that are likely to be highly variable over a set of messages of a particular type. Date/time stamps, for example, are nearly unique for each event message, with two event messages having an identical date/time stamp only in the case that the two event messages are generated within less than a second of one another. Additional examples of parameters include global unique identifiers (“GUIDs”), hypertext transfer protocol status values (“HTTP statuses”), universal resource locators (“URLs”), network addresses, and other types of common information entities that identify variable aspects of an event type. By contrast, the phrase “Repair session” in event message 1302 likely occurs within each of many repair session event messages. In FIG. 18, the parametric-valued tokens in the event message following initial token recognition are indicated by shading. For example, initial token recognition determines that the first token 1806 is a date and the second token 1807 is a time. The tokens identified as parameters are identified by shaded rectangles, such as shaded rectangle 1810 of the date 1806 and shaded rectangle of 1812 of the time 1807. The parametric-valued tokens are discarded leaving the non-parametric text strings, natural language words and phrases, punctuation, parentheses, and brackets. Various types of symbolically encoded values, including dates, times, machine addresses, network addresses, and other such parameters can be recognized using regular expressions or programmatically. For example, there are numerous ways to represent dates. A program or a set of regular expressions can be used to recognize symbolically encoded dates in any of the common formats. It is possible that the token-recognition process may incorrectly determine that an arbitrary alphanumeric string represents some type of symbolically encoded parameter when, in fact, the alphanumeric string only coincidentally has a form that can be interpreted to be a parameter. The currently described methods and systems do not depend on absolute precision and reliability of the event-message-preparation process. Occasional misinterpretations generally do not result in mistyping of event messages and, in the rare circumstances in which event messages may be mistyped, the mistyping is most often discovered during subsequent processing. In the implementation shown in FIG. 18, the event message 1602 is subject to textualization in which an additional token-recognition step of the non-parametric portions of the event message is performed in order to remove punctuation and separation symbols, such as parentheses and brackets, commas, and dashes that occur as separate tokens or that occur at the leading and trailing extremities of previously recognized non-parametric tokens, as shown by underlining in the retokenized event message 1814 in FIG. 18. For example, brackets and a coma 1818 are underlined. The punctuation, parentheses, and brackets are discarded leaving a textualized event message of interest 1820 that comprises only the non-parametric text strings and natural language words and phrases of the original event message 1302. The textualized event message 1820 represents an event type. Other textualized event messages with the same non-parametric text strings and natural language words and phrase as the textualized event messages 1820 are the same event type. Another textualized event message with one or more different non-parametric text strings or natural language words and phrase from those of the textualized event messages 1820 is of a different event type.

### Methods to Analyze and Detect Anomalies of Event Sources

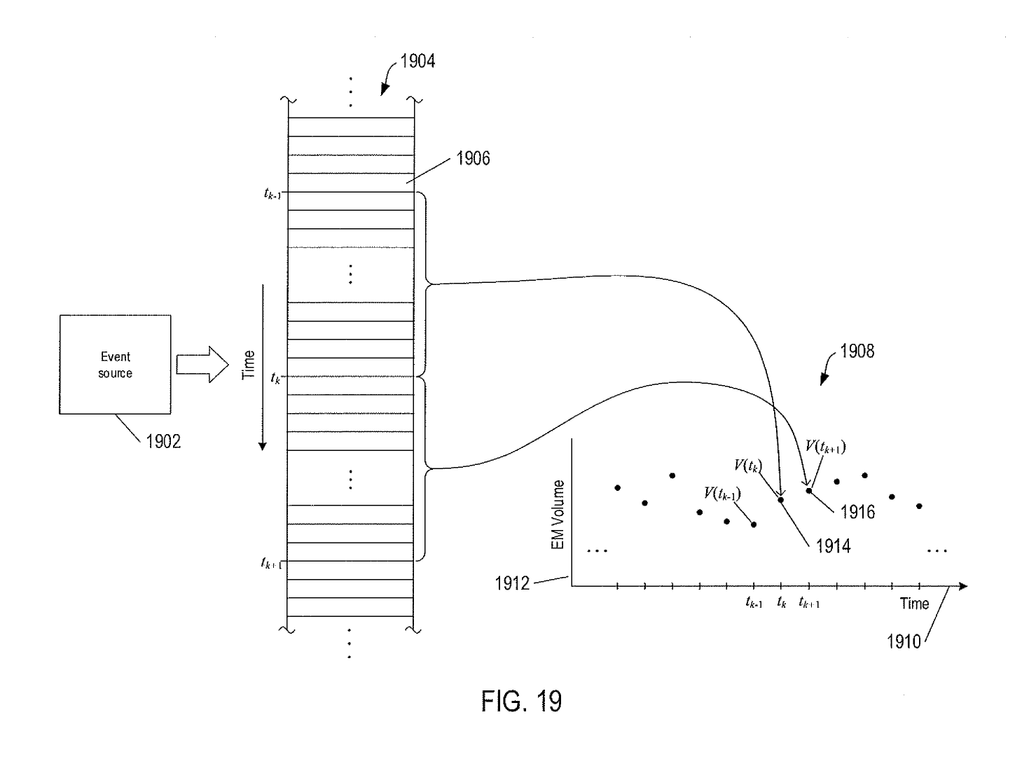

FIG. 19 shows quantification of event messages generated by an event source 1902. The event source 1902 runs on a computer system and generates a stream of event messages that are sent by a log management agent that also runs on the computer system to a log management server (not shown) that records the event messages in an event log 1904 as described above. Each rectangle, such as rectangle 1906, represents an event message generated by the event source 1902. As described above, when the log management server receives an event message, the log management server writes a time stamp in the event message, indicating the time when the event message is recorded in the event log 1906. The log management server maintains one or more meta-data records of various properties of the event source based on the event messages generated by the event source. For example, the log management server creates a meta-data record of the volume (i.e., number) of event messages received in separate time intervals. The meta-data record of volume of event messages is stored in a data-storage device as volume time series data. FIG. 19 includes a plot of volume time series data 1908 that represents the volume of event messages generated in adjacent, equal duration time intervals. Horizontal axis 1910 represents time. Vertical axis 1912 represents a range for the volume of event messages. Dots represent volume data points of the volume time series data. For example, dot 1914 represents the volume of event messages, denoted by V(tₖ), generated by the event source 1902 with time stamps in the time interval (tₖ₋₁, tₖ], where positive integer “k” is a time index. Dot 1916 represents the volume of event messages, denoted by V(tₖ₊₁), generated by the event source 1902 with time stamps in the time interval (tₖ, tₖ₊₁]. The volume time series data shown displayed in plot 1908 represents one property of the event source 1902. In this example, the property is the volume, or number, of event messages generated by the event source 1902 per interval of time and can used to monitor and analyze the behavior the event source 1902 as described below.

Other properties of an event source include event message velocity, event message acceleration, and event message variety. Each of these properties is a different type of meta-data obtained from the event log associated with the event source. The log management server creates a meta-data record of the velocity, acceleration, and variety of event messages received in separate time intervals.

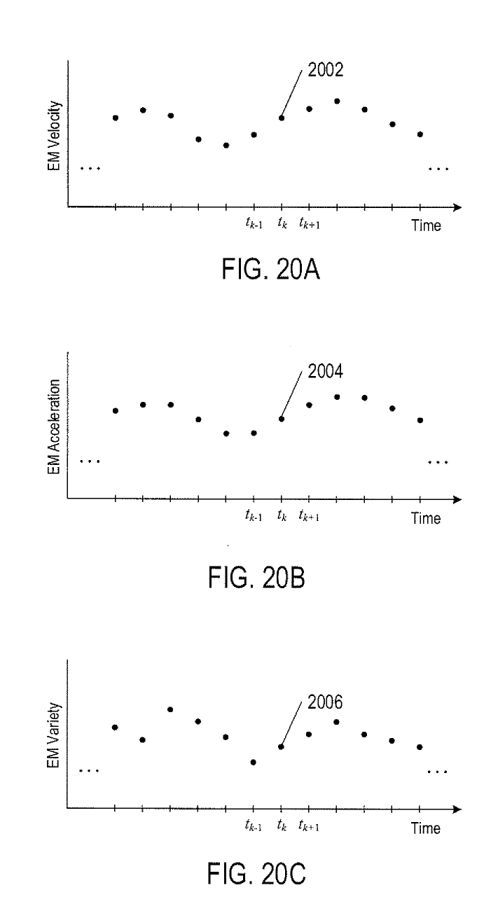

FIGS. 20A-20C show three examples of velocity, acceleration, and variety time series data, respectively, for the event source 1902 shown in FIG. 19. Velocity time series data represents how the volume of messages changes over time. The velocity of event messages at time t; may be approximated as follows:

$$v ( {t}_{k} ) = \frac{V ( {t}_{k + 1} ) - V ( {t}_{k - 1} )}{{t}_{k + 1} - {t}_{k - 1}} \qquad ( 1 )$$

In FIG. 20A, dot 2002 represents the velocity, or average change in the volume, of event messages at the time tₖ. Acceleration time series data represents how the velocity of time series is changing over time or acceleration of event messages over time. The acceleration of event messages at time tₖ may be approximated as follows:

$$a ( {t}_{k} ) = \frac{v ( {t}_{k + 1} ) - v ( {t}_{k - 1} )}{{t}_{k + 1} - {t}_{k - 1}} \qquad ( 2 )$$

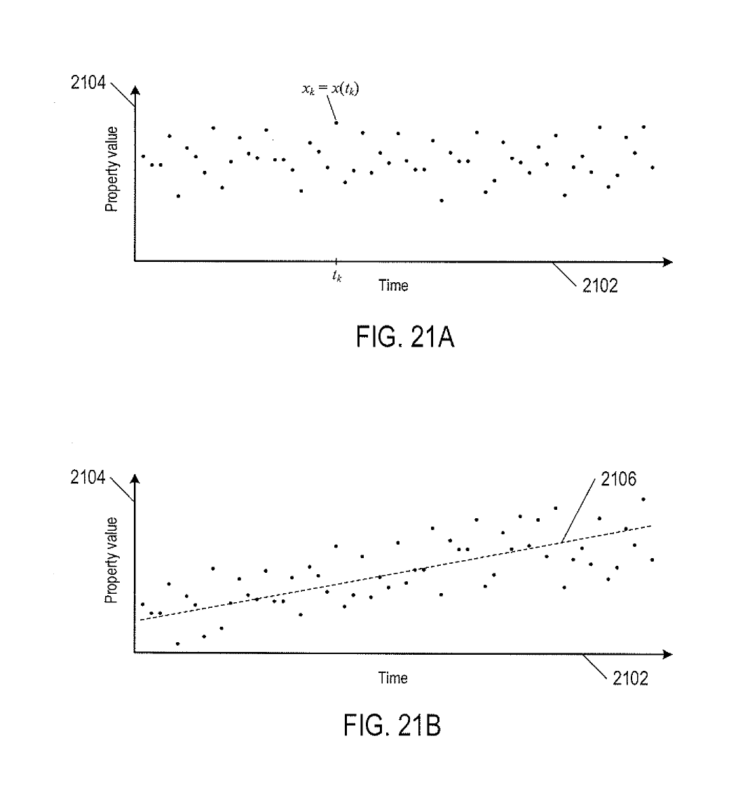

In FIG. 21A, dot 2004 represents the acceleration, or average change in the velocity, of event messages at the time tₖ. The log management server determines the event type of each event message as described above with reference to FIG. 18. For example, event messages may describe any number of various types of events, including warnings, errors, input, and output events. The log management server counts the variety of event messages generated in each time interval to form variety time series data as shown in FIG. 20C. Each variety data point represents the number of different event types generated within a corresponding time interval. For example, dot 2006 represents the number of different event types generated in the time interval (tₖ₋₁, tₖ].

Each sequence of meta time series data generated by quantifying a particular property of the event source from event messages in the event log, as described above with reference to FIGS. 19 and 20, represents a characteristic, attribute, or condition of the event source 1902 and is, in general, called “property time series data.” For example, the properties represented by the time series data in FIGS. 19-20 are volume, velocity, acceleration, and variety. The meta data shown in FIG. 19 is called “volume time series data;” the meta data shown in FIG. 20A is called “velocity time series data;” the meta data shown in FIG. 20B is called “acceleration time series data;” and the meta data shown in FIG. 20C is called “variety time series data.”

Property time series data generated by an event source is represented by

Xₖ=X(tₖ) (3)

where Xₖ represents a discrete property data point in a sequence of property time series data.

For example, Xₖ represents the volume or variety of event messages generated in the time interval (tₖ₋₁, tₖ]. A sequence of N consecutive property time series data points Xₖ is represented by

X={Xₖ}ₖ₌₁^{N} (4)

The time-series data can be collected and stored in a data-storage device.

The values of the property data points may have a tendency to follow a particular shape or pattern and may be categorized as “trendy.” Alternatively, the values of the data points in the property time series data X may be randomly distributed and categorized as “non-trendy.” Property data points may be decomposed into trendy and non-trendy components as follows:

X(tₖ)=x(tₖ)+trend(tₖ) (5)

where

x(tₖ) is the stochastic (i.e., random) component of the property data point X(tₖ); and

trend(tₖ) is the trend component of the property data point X(tₖ).

For non-trendy property time series data X, the trend component is essentially zero (i.e., trend(tₖ)≈0) and each property data point in the property time series data X of Equation (5) reduces to

X(tₖ)=x(tₖ) (6)

On the other hand, for trendy property time series data X, the trend component in Equation (5) is not equal to zero (i.e., trend(tₖ)≠0) and the property data point representation in Equation (5) holds.

FIGS. 21A-21B show example plots of non-trendy and trendy property time series data, respectively. In FIGS. 21A-21B, horizontal axes 2102 represent time and vertical axes 2104 represents ranges of property data point values. In FIG. 21A, values of the data points of property time series data are randomly distributed and do not exhibit a trend. By contrast, in FIG. 21B, values of the data points of property time series data exhibit a linear trend in which the values of the data points tend to increase with time as represented by dashed line 2106.

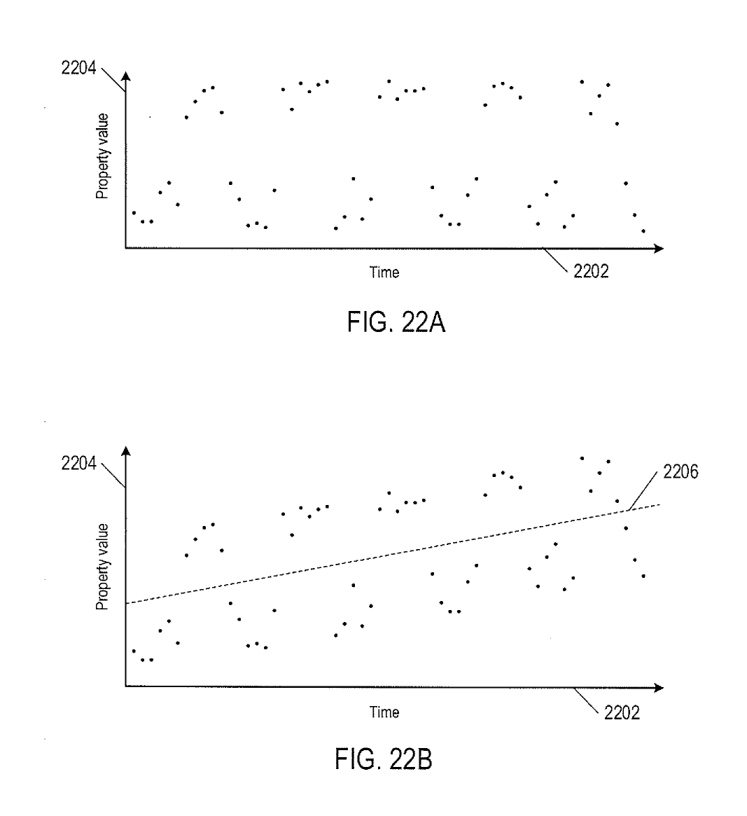

The property time series data may also be trendy or non-trendy and periodic. FIGS. 22A-22B show example plots of non-trendy and trendy periodic property time series data, respectively. In FIGS. 22A-22B, horizontal axes 2202 represent time and vertical axes 2204 represents ranges of property data point values. In FIG. 22A, values of the data points of property time series data are periodically distributed and do not exhibit a trend. By contrast, in FIG. 22B, values of the data points of property time series are periodic and also exhibit a trend in which the values of the data points tend to increase with time as represented by dashed line 2206.

Thresholds are computed for the property time series data based on historical patterns in the property time series data collected over a period of time, such as a day, days, a week, weeks, a month or a number of months. In one implementation, the thresholds determined from the property time series data are time-independent thresholds. Time-independent thresholds can be determined for trendy and non-trendy randomly distributed property time series data as illustrated in FIGS. 21A-21B. In another implementation, the thresholds determined from the property time series data are time-dependent or dynamic thresholds. Dynamic thresholds can be determined for trendy and non-trendy periodic property time series data as illustrated in FIGS. 22A-22B. Methods and systems to determine time-independent thresholds are described in US patent application owned be VMware, Inc. and identified as US Publication No. 2015/03791101A1, filed Jun. 25, 2014, which is herein incorporated by reference. Methods and systems to determine dynamic thresholds are described in US patent application owned be VMware, Inc. and identified as US Publication No. 2014/0298098A1, filed Mar. 29, 2013, which is herein incorporated by reference. Methods and systems distinguish trendy and non-trendy time series data are described in both of US Publications incorporated by reference.

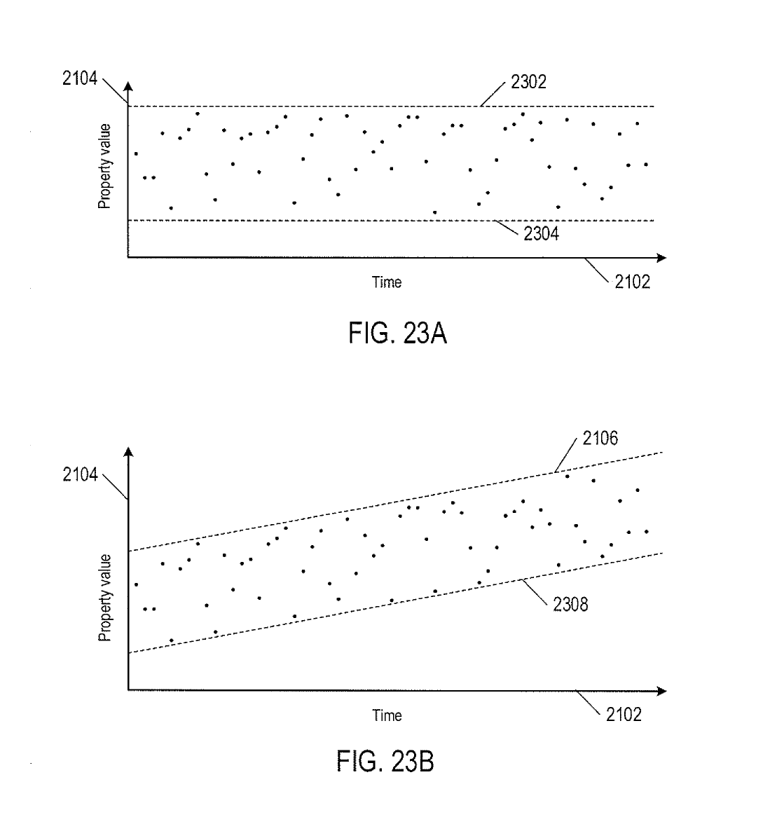

Because the property time series data shown in FIGS. 21A-21B are randomly distributed non-trendy and trendy property time series data, time-independent thresholds can be determined using the methods and systems described in US Publication No. 2015/03791101A1, as shown in FIGS. 23A-23B. In FIG. 23A, dashed lines 2302 and 2304 represent upper and lower thresholds, respectively, for the randomly distributed non-trendy property time series data shown in FIG. 21A. In FIG. 23B, dashed lines 2306 and 2308 represent upper and lower thresholds, respectively, for the property time series data shown in FIG. 21B.

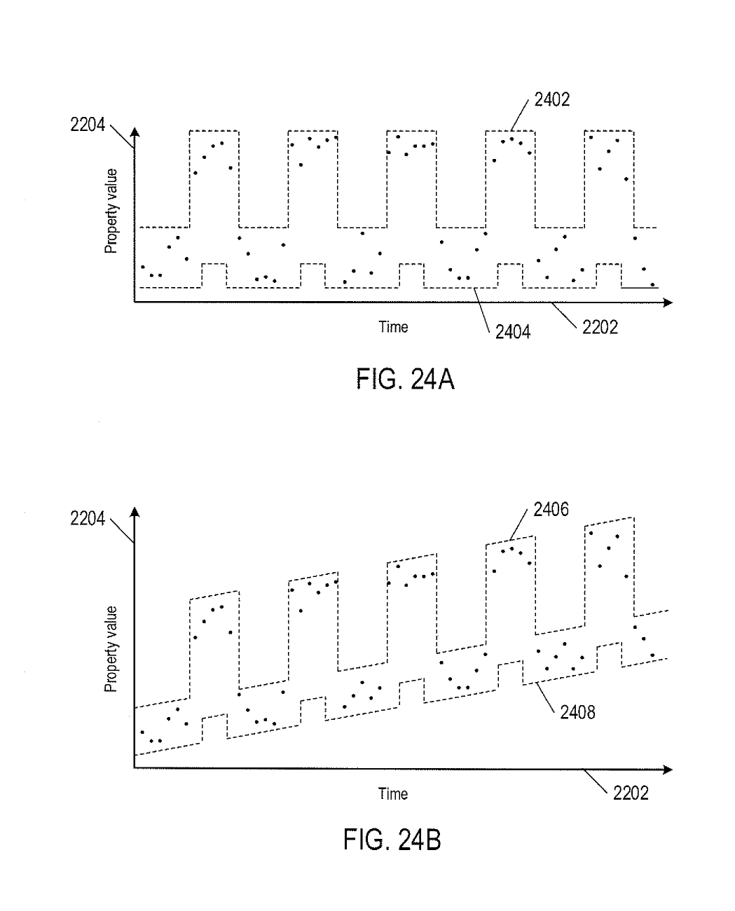

As described in US Publication No. 2014/0298098A1, unlike time-independent thresholds, dynamic thresholds accommodate periodicity in the distribution of property time series data. Because the property time series data shown in FIGS. 22A-22B are randomly distributed non-trendy and trendy property time series data, dynamic thresholds may be determined using the methods and systems described in US Publication No. 2014/0298098A1, as shown in FIGS. 24A-24B. In FIG. 24A, dashed periodic curve 2402 represents an upper threshold that tracks the periodicity of the larger data values of the non-trendy periodic property time series data shown in FIG. 22A. Dashed periodic curve 2404 represents a lower threshold that tracks the periodicity of the smaller data values of the non-trendy periodic property time series data shown in FIG. 22A. In FIG. 24B, dashed periodic curve 2406 represents an upper threshold that tracks the periodicity and increasing trend of the larger data values of the periodic property time series data shown in FIG. 22A. Dashed periodic curve 2408 represents a lower threshold that tracks the periodicity and increasing trend of the smaller data values of the periodic property time series data shown in FIG. 22A.

The thresholds are used to determine dominant and typical ranges for the property time series data, determine abnormal states of the event source, and predict behavior of the event source at a later time. A threshold is a normalcy bound for the property time series data. When property data points do not violate a threshold, the event source is operating in a normal state or as expected. In other words, the property time series data does not indicate any non-characteristic behavior from the event source. When property data points violate a threshold, the event source is operating in an abnormal state. A violation of a threshold is an indication that the event source may have entered into anomalous behavior, which triggers a property digression alert.

Property digression alerts are triggered when one or a sequence of property data points violate an upper or lower threshold for the property time series data. Property data points violate an upper threshold when

X(tₖ)≥Thᵤₚₚₑᵣ (7)

where Thᵤₚₚₑᵣ is an upper threshold.

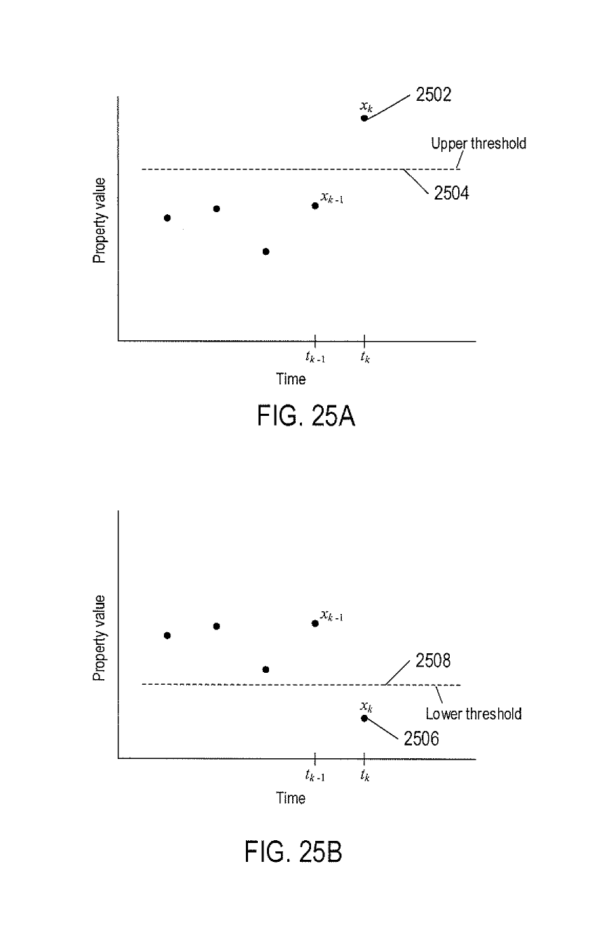

FIG. 25A shows an example of a property data point 2502 of property time series data that is greater than an upper threshold represented by dashed line 2504. Property data points violate a lower threshold when

X(tₖ)≤Th_{lower} (8)

where Th_{lower} is a lower threshold.

FIG. 25B shows an example of a property data point 2506 of property time series data that is less than a lower threshold represented by dashed line 2508. The upper and lower thresholds may be time-independent thresholds determined as described in incorporated US Publication No. 2015/03791101A1. Alternatively, the upper and lower thresholds may be time-independent thresholds determined as described in incorporated US Publication No. 2014/0298098A1.

When a threshold is violated, as described above with reference to Equation (7) or Equation (8), a property digression alert is generated, indicating that the event source has entered an abnormal state. The property digression alert may be displayed in a graphical user interface of a systems administration console along with the property identified so that a systems administrator is alerted to the type of problem with the event source. For example, when one of volume, velocity, or acceleration data points violate an associated threshold, a corresponding property digression alert is generated, indicating anomalous behavior of the event source. The log management server may generate a recommendation to allocate additional storage space to accommodate the increased number of incoming event messages from the event source.

Other alerts may be generated when physical or virtual resources of a computer system or server computer, VM, or container used to run the event source violate associated thresholds at approximately the same time. An information technology (“IT”) management server of a distributed computing system receives and stores resource time series data generated by various physical and virtual resources of the computer system that runs the event source and from other computer system within a distributed computing system. The physical resources include processors, memory, network traffic, network connections, and storage of each computer system, mass-storage devices, and other physical components of the distributed computing system. The virtual resources also include virtual processors, memory, network connections and storage. The IT management server monitors physical and virtual resources by collecting resource time series data from each of the physical and virtual resources. Resource time series data includes physical and virtual CPU usage, amount of memory, network throughput, network traffic, and amount of storage. CPU usage is a measure of CPU time used to process instructions of an application program or operating system as a percentage of CPU capacity. High CPU usage may be an indication of usually large demand for processing power, such as when an application program enters an infinite loop. Amount of memory is the amount of memory (e.g., GBs) a virtual or physical object uses at a given time. Network traffic is the amount of data, such as number of data packets, moving through a given network at a given point in time. Data points of resource time series data may also be represented as described above with reference to Equation (3). When data points of resource time series data violate an associated threshold in the same manner as described above with reference to FIGS. 25A-25B, the IT management server generates a corresponding resource alert notifying a systems administrator of the anomalous behavior of the physical or virtual resource.

When a property digression alert is triggered as a result of a threshold violation, as described above with reference to FIGS. 25A-25B, the property digression alert may be grouped with other resource alerts that occurred within a property alert time window of when the property digression alert occurred. The property alert time window is represented by [tₖ−ε, tₖ+ε], where ε is a user selected parameter greater than zero, and tₖ is the time when the property alert is generated. The parameter ε may be a fraction of tenths, hundredths, or thousands of a second. The parameter ε may be less than an hour or more than two or three hours. Alerts generated by threshold violations of physical or virtual resources of the computer system that runs or supports the event source may be grouped with the property digression alert in order to identify a correlation between anomalous behavior of the event source and anomalous behavior of the resources.

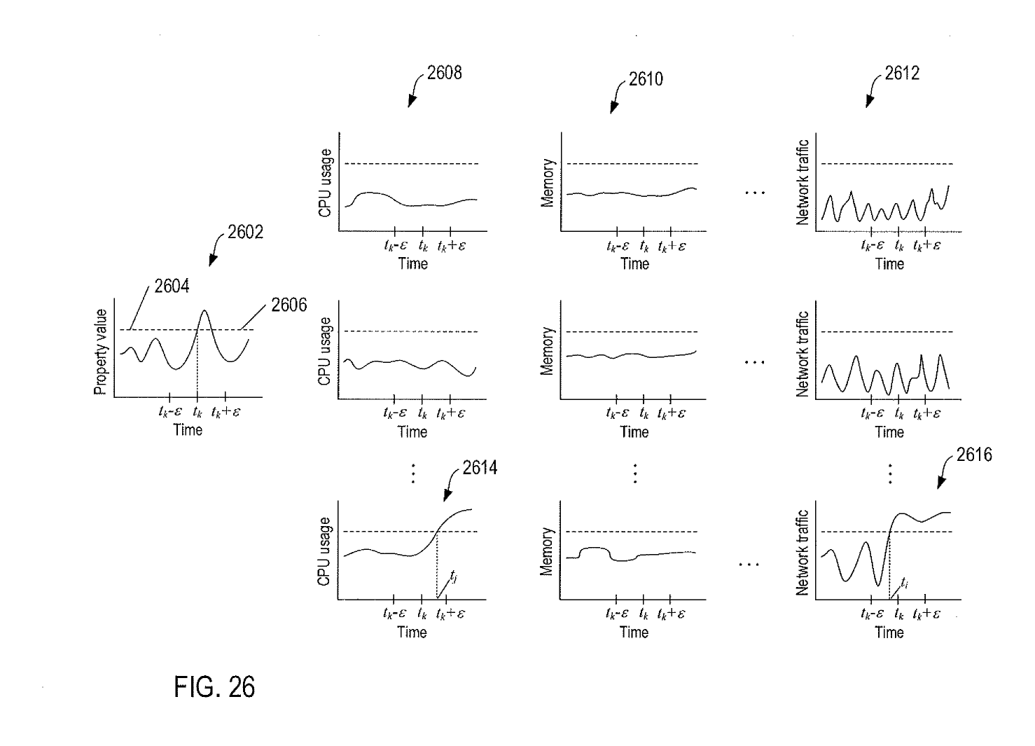

FIG. 26 shows an example of identifying alerts of resources that occur within a property alert time window centered at the time of a property digression alert. Plot 2602 shows property time series data represented by a curve 2604 that violates an upper threshold 2606 at time tₖ. The property time series data represent a property of an event source over time. The violation triggers a property digression alert, indicating that the performance of the event source is abnormal or anomalous. Plot 2602 also shows lower and upper limits of a property alert time window [tₖ−ε, tₖ+ε] centered at the time tₖ when the threshold violation occurred. The property alert time window is applied to resource time series data of other resources of the computer system that runs the event source or resources of a larger distributed computing system that includes the computer system that runs the event source. Column 2608 shows plots of CPU usage versus time for a number of CPUs; column of 2610 shows plots of memory usage versus time for a number of memories; and column 2612 shows plots of network traffic versus time for a number of different networks. The CPUs, memories, and network traffic may be for the same computer system used to run the event source. Alternatively, CPUs, memories, and network traffic may be for a distributed computing system that includes the computer system that runs the event source. The curve in each plot represents data points of resource time series data. A dashed line in each plot represents a corresponding upper threshold. Each plot includes the property alert time window [tₖ−ε, tₖ+ε] centered at the time tₖ when the property digression alert occurred in plot 2602. Threshold violations occur in plots 2614 and 2616. In plot 2614, the threshold violation for a CPU occurs within the property alert time window [tₖ−ε, tₖ+ε] after the time tₖ. In plot 2616, the threshold violation for network traffic occurs within the property alert time window [tₖ−ε, tₖ+ε] before the time tₖ. The threshold violations in plots 2614 and 2616 correlate with the property digression alert shown in plot 2602 and are reported along with the property digression alert to the system administrator console.

Threshold violations of resources of a computer system that runs the event source and correlate in time with a property digression alert of the event source may be given a higher priority alert than resources with threshold violations located on other computer systems. For example, alerts resulting from threshold violations shown in plots 2614 and 2616 for a CPU and network traffic of a server computer that runs the event source with the property digression alert in plot 2602 would receive a higher priority alert than if CPU and network traffic alerts occurred on other server computers that do not run the event source.

Property time series data may be recorded over a historical period of time, such as days, weeks, or months, and abnormal states of the event source that occurred in the past may correlate with anomalies of resources recorded over the same historical period of time. Historical co-occurrences of property digression alerts with alerts created by anomalous behavior of resources in the computer system that runs the event source may be used to generate recommendations to correct correlated anomalous behavior of the event source and the resources.

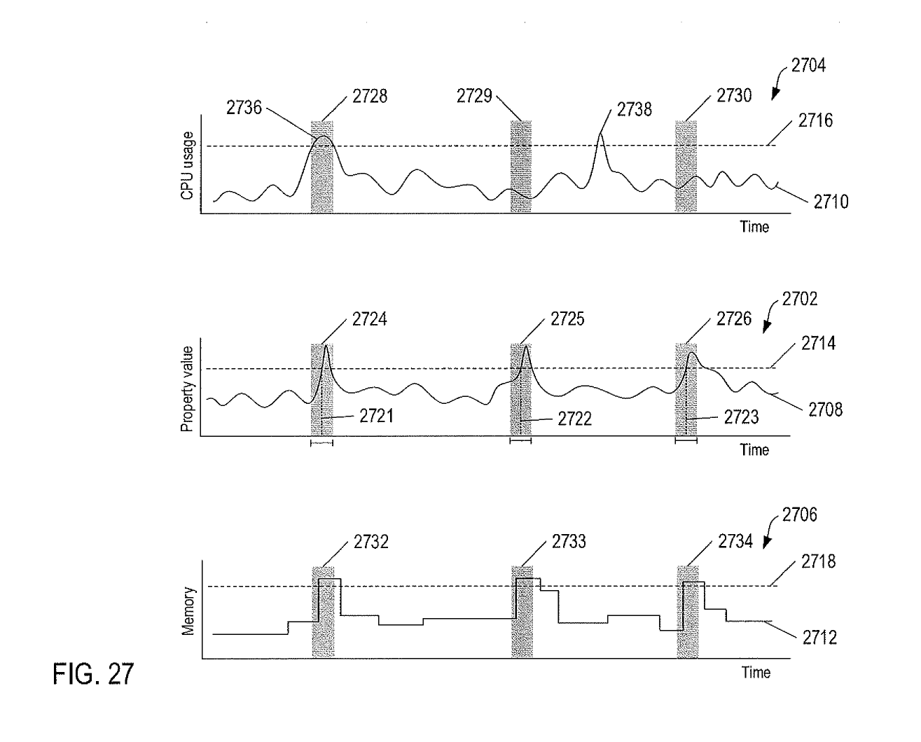

FIG. 27 shows a plot of historical property time series data 2702, a plot of historical CPU usage 2704, and a plot of historical memory usage 2706. In plot 2702, curve 2708 is property time series data generated by an event source over a historical period of time. For example, the historical period of time may refer to a period of time in which property time series data is collected over a day, a week, two weeks, a month, or a number of months. In plot 2704, curve 2710 is historical time series data of CPU usage for a CPU of a computer system that runs the event source over the same period of time. In plot 2706, curve 2712 is historical time series data of memory usage of the same computer system over the same period of time. Dashed lines 2714, 2716, and 2718 represent upper thresholds for the associated time series data in corresponding plots 2702, 2704, and 2706. Dashed lines 2721-2723 identify three times when the property time series data 2708 violated the threshold 2714. Shaded regions 2724-2726 represent time windows centered at the times 2721-2723 when the property time series data 2708 violated the threshold. The duration of time windows may be determined based on the resource. For example, for memory and CPU usages, the duration of the time windows may be 1 second, 5 seconds, 10 seconds, 20 seconds, or up to 2 minutes in length. For other resources, such as network traffic, the duration of the time windows may be longer, such 10 minutes, 30 minutes or an hour. Shaded regions 2728-2730 represent time windows in plot 2704 that correspond to the time windows 2724-2726. Shaded regions 2732-2734 represent time windows in plot 2706 that correspond to the time windows 2724-2726. CPU usage 2710 exhibits two threshold violations 2736 and 2738. The first threshold violation 2736 occurs in the time window 2728, which correlates with threshold violation in the time window 2714. The second threshold violation 2738 does not occur within any of the time windows 2728-2730 and does not correlate with any of the threshold violations of the property time series data. On the other hand, the memory usage exhibits three threshold violations that occur in the time windows 2732-2734, which correlate with the time windows 2724-2726 and suggests that the historical anomalous behavior of the event source correlates with anomalous behavior of memory usage.

Let Nᵣ denote the number of historical threshold violations of resource time series data over a period of time for a resource of a computer system used to run an event source. Let Nₚ denote the number of historical property digression alerts of the property time series data over the same period of time for the event source. The intersection Nᵣ∩Nₚ represents the number of times the threshold violations by the resource time series data occur within time windows of the property digression alerts of the event source. The resource and event source are identified as correlated when the fraction of the resource alerts that occur within time windows of the property digression alerts satisfies the condition:

$$\frac{{N}_{r} ⋂ {N}_{p}}{{N}_{p}} \geq {M}_{overlap} \qquad ( 9 )$$

where Mₒᵥₑᵣₗₐₚ is a minimum correlation of intersecting threshold violations.

The minimum correlation Mₒᵥₑᵣₗₐₚ may be equal to 0.90, 0.85, 0.80, or 0.75. Depending on the type of resource and event source, recommendations for addressing the corresponding threshold violations may be generated in response.

The methods described above may be applied to a single event source, such as an operating system, application program, VM or a container and used to generate recommendations that address the problems identified in the examples of FIGS. 26 and 27. For example, suppose the event source is a server application program running in a VM deployed on a server computer. At certain times, demand for the server application program is high, which increases the property time series data and increases the demand for memory. These increases may result in time correlated abnormal states for the event source and the memory as shown in either FIG. 26 or FIG. 27. Recommendations to remedy the problem include allocating more memory to the server application program, allocating more memory to the VM, or migrating the VM to a different server computer with more available memory.

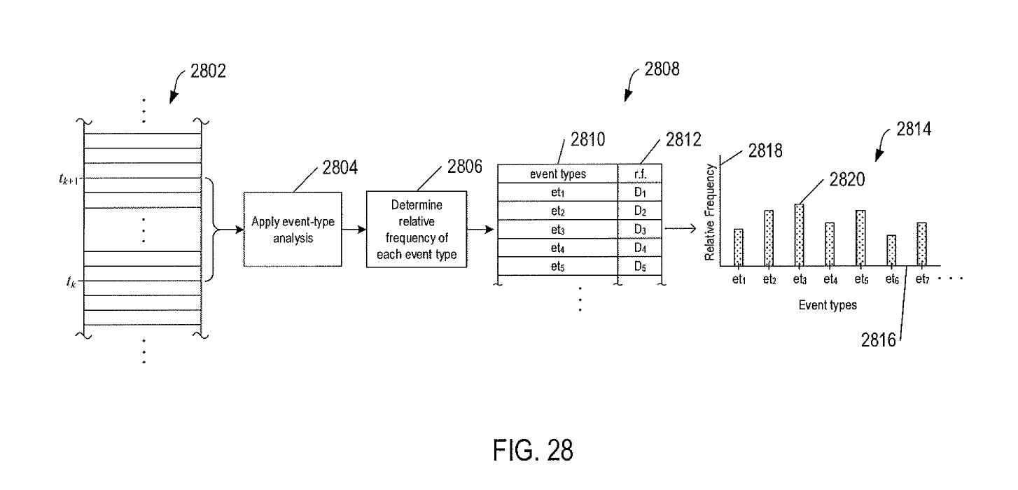

Methods include monitoring changes in the entropy of event types generated by an event source. FIG. 28 shows determining event-type logs from event messages recorded in an event log 2802. In block 2804, event-type analysis is applied to each event message to determine the event type. Event-type analysis reduces the event message to text strings and natural-language words and phrases (i.e., non-parametric tokens), as described above with reference to FIG. 18. In block 2806, relative frequencies of the event types are computed according to

$${D}_{i} ( {t}_{k} ) = \frac{n ( {et}_{i} )}{{N}_{k}} \qquad ( 10 )$$

where
n(etᵢ) is the number of times an event type, denoted by etᵢ, appears in the event messages recorded in the time interval (tₖ₋₁, tₖ]; and
Nₖ is the total number of event messages collected in the time interval (tₖ₋₁, tₖ].
   An event-type log 2808 is formed from the different event types and associated relative frequencies. The event-type log 2808 comprises a list of the different event types 2810 in the event messages and corresponding relative frequencies 2812 of each event type. FIG. 28 also shows a histogram 2814 of the event type distribution. Horizontal axis 2816 represents the event types. Vertical axis 2818 represents a range of relative frequencies. Shaded bars represent the relative frequency of each event type. For example, shaded bar 2820 represents the relative frequency D₃ of the event type et₃.

The normalized entropy is computed for each distribution of event types of event messages generated by an event source as follows:

$$H ( D , {t}_{k} ) = - {\sum }_{i = 1}^{M} {D}_{i} ( {t}_{k} ) {log}_{M} {D}_{i} ( {t}_{k} ) \qquad ( 11 a )$$

where
Dᵢ(tₖ) is the relative frequency of the event type etᵢ generated within the time interval (tₖ₋₁, tₖ];
M is the number of event types; and
H(D, tₖ)ε[0,1] is normalized.

When the normalized entropy violates an entropy threshold given by:

H(D,tₖ)≥Th_{entropy} (11b)

where Th_{entropy} is an entropy threshold,

the event source is behaving abnormally.

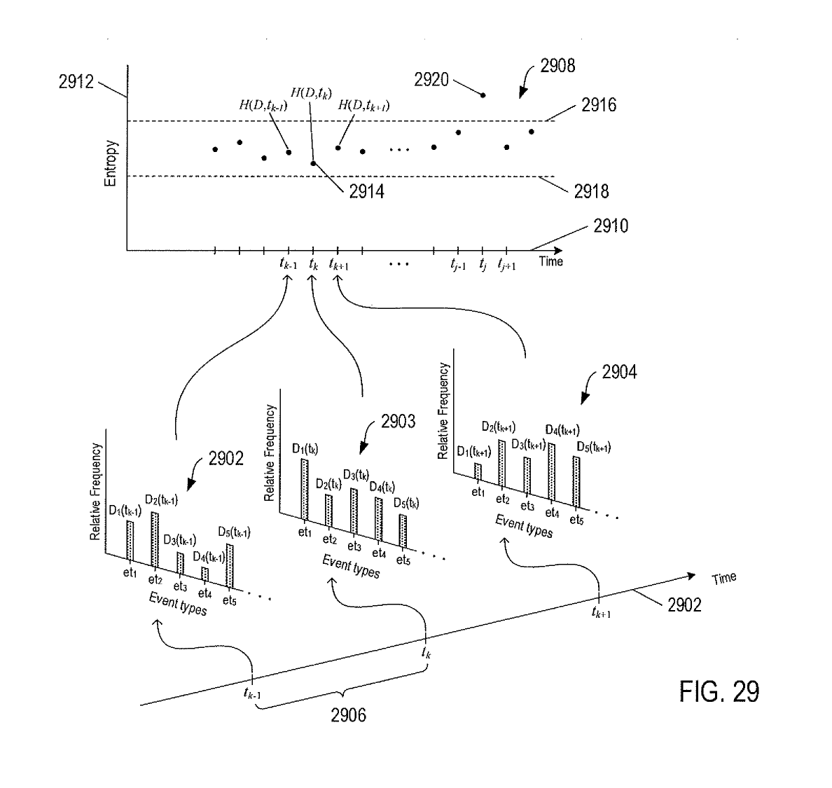

FIG. 29 shows example entropies computed for distributions of event types of event messages generated by an event source. Event type distributions 2902-2904 are computed for event messages generated in corresponding time intervals as described above with reference to FIG. 28. For example, event type distribution 2903 is computed for event messages generated by the event source in time interval 2906. FIG. 29 also shows a plot of entropies 2908. Horizontal axis 2910 represents time. Vertical axis 2912 represents a range of entropy values. The event type entropies computed for event messages over time form a sequence of entropy time series data with values of entropy data points given by Equation (11). Dots, such as dot 2914, represent entropy data points in a sequence of entropy time series data. Dynamic or time independent thresholds are computed for the entropy time series data as described in incorporated US Publication No. 2014/0298098A1 and US Publication No. 2015/03791101A1. In FIG. 29, dashed lines 2916 and 2918 represent upper and lower thresholds, respectively, for the entropy time series data. Dot 2920 represents an entropy data point that has violated the upper threshold 2916, which triggers an alert on a system administration console.

Anomalous behavior identified by an entropy threshold violation is an indication of instability and possibly a need to move the event source to a different computer system with more stable entropies for the event sources running on the computer system. The log management server maintains a record of a standard deviation of entropies for each of the computers systems in a distributed computing system. A standard deviation of entropies may be computed for each of the different computer systems in a distributed computing system as follows:

$$std ( H ) = \sqrt{\frac{1}{Q} {\sum }_{i = 1}^{Q} {( {H}_{i} ( D , {t}_{k} ) - μ )}^{2}} \qquad ( 11 c )$$

where
Q is the number of event sources running on the computer system;
subscript “i” is an event source index; and
μ is the mean of the entropies for the Q different event sources running on the computer system.
   When the entropy of an event source violates the entropy threshold as represented by Equation (11b), or the entropy spikes repeatedly over a period time, the workload of the event source may be moved to the computer system with the smallest standard deviation of entropies (i.e., minimum std(H)). For example, suppose the threshold violation in plot 2908 corresponds to an event source of a VM running on a server computer. When the alert is triggered, the log management server may generate a recommendation to migrate the VM to the server computer within a distributed computing system that has a more stable entropy as indicated by a minimum associated standard deviation of entropies.

The various properties of an event source may stay within associated historical boundaries, but there may be a conflict between different properties. Two or more sequences of property time series data generated for two or more properties of an event source as described above with reference to FIGS. 19 and 20 may be analyzed together to identify anomalous behavior of the event source.

Consider a collection of sequences of property time series data for an event source represented by

{X^{p}}ₚ₌₁^{P} (12)

where
P is the number of different properties of the event source;
superscript p is a property index of the event source; and
Xₚ is a sequence of property time series data {Xₖ^{p}}ₖ₌₁^{N} for the p-th property of the event source as represented in Equation (4).

For example, the properties of an event source described above with reference to FIGS. 19 and 20 may be represented as follows: X¹ may represent volume time series data, X² may represent velocity time series data, X³ may represent acceleration time series data, and X⁴ may represent variety time series data. Methods analyze the event source in terms of conflicts between two or more properties by treating the property data points of two or more sequences of property time series data as coordinate data points or as vectors in a two-dimensional or higher-dimensional space.

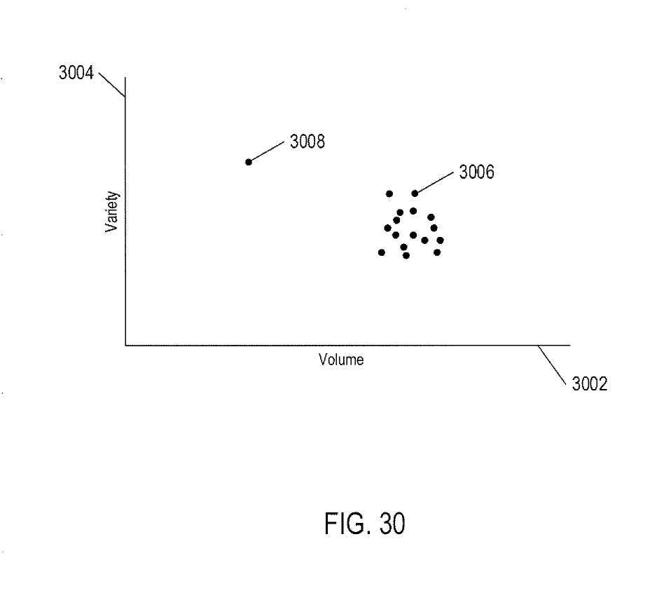

FIG. 30 shows an example plot of volume versus variety time series coordinate data points. Horizonal axis 3002 represents a range of volumes for event messages of an event source. Vertical axis 3004 represents a range of varieties of event messages of the event source. Dots represent coordinate data points formed from corresponding volume data points and variety data points. For example, dot 3006 may represent the coordinate data point (Xₖ^{vol}, Xₖ^{var}), where Xₖ^{vol}=V(tₖ) described above with reference to FIG. 19, and Xₖ^{var} represents the number of different event types generated in the time interval (tₖ₋₁, tₖ] as described above with reference to FIG. 20C. The coordinate data point 3008 is an outlier that indicates a significant decrease in the volume of event messages while the variety of event messages increased, which may be an indication of a problem with the event source.

In one implementation, anomalous behavior may be determined by detecting local outlier coordinate data points for two or more property time series data. A local outlier factor is computed for each coordinate data point in two or more sequences of property time series data. Consider the case of two sequences of property time series data. Computation of local outlier factors for each coordinate data point can be extended to any number of sequences of property time series data.

Computing a local outlier factor begins by computing a distance between each pair of coordinate data points in the two sequences of property time series data. Let C={(Xₖ^{p}, Xₖ^{q})}ₖ₌₁^{N} be a cluster of coordinate data points of property time series data for two properties denoted p and q of the same event source. The distance between any points in the cluster C may be computed as follows:

$$dist ( {X}_{k}^{p , q} , {X}_{j}^{p , q} ) = \sqrt{{( {X}_{k}^{p} - {X}_{j}^{p} )}^{2} + {( {X}_{k}^{q} - {X}_{j}^{q} )}^{2}} \qquad ( 13 )$$

where
Xₖ^{p,q} represents the coordinate (Xₖ^{p}, Xₖ^{q}); and
Xⱼ^{p,q} represents the coordinate (Xⱼ^{p}, Xⱼ^{q}).
   A local outlier factor (“LOF”) is determined for each coordinate data point Xₖ^{p,q} in C. The magnitude of the LOF is used to determine if the corresponding coordinate data point is an outlier, which triggers an alert.

The distances of coordinate data points Xⱼ^{p,q} to the coordinate data point Xₖ^{p,q} are rank ordered and the K-th nearest neighbor distance, also called the K-distance, is determined and denoted by dist_{K}(Xₖ^{p,q}), where K is a natural number. Given the K-distance, a K-distance neighborhood of the coordinate data point Xₖ^{p,q} with a distance from the point Xⱼ^{p,q} that is less than or equal to the K-distance of the coordinate data point Xₖ^{p,q}:

N_{K}(Xₖ^{p,q})={Xⱼ^{p,q}∈C\{Xₖ^{p,q}}|dist(Xₖ^{p,q},Xⱼ^{p,q})≤dist_{K}(Xₖ^{p,q})} (14)

A local reachability density is compute for the coordinate data point Xₖ^{p,q} as follows:

$${lrd}_{K} ( {X}_{k}^{p , q} ) = \frac{‖ {N}_{k} ( {X}_{k}^{p , q} ) ‖}{{\sum }_{{X}_{j}^{p , q} ∈ {N}_{K} ( {X}_{k}^{p , q} )} reach - {dist}_{K} ( {X}_{k}^{p , g} , {X}_{j}^{p , q} )} \qquad ( 15 )$$

where
∥N_{K}(Xₖ^{p,q})∥ is the number of coordinate data point in the K-distance neighborhood N_{K}(Xₖ^{p,q}); and
reach−dist_{K}(Xₖ^{p,q}, Xⱼ^{p,q}) is the reachability distance of the coordinate point Xₖ^{p,q} to the coordinate data point Xⱼ^{p,q}.

The reachability distance is given by:

reach−dist_{K}(Xₖ^{p,q},Xⱼ^{p,q})=max{dist_{K}(Xₖ^{p,q}),dist(Xₖ^{p,q},Xⱼ^{p,q})} (16)

An LOF is computed for the coordinate data points Xₖ^{p,q} as follows:

$${LOF}_{K} ( {X}_{k}^{p , q} ) = \frac{{\sum }_{{X}_{k}^{p , q} ∈ {N}_{K} ( {X}_{k}^{p , q} )} \frac{{lrd}_{k} ( {X}_{j}^{p , q} )}{{lrd}_{k} ( {X}_{k}^{p , q} )}}{‖ {N}_{K} ( {X}_{k}^{p , q} ) ‖} \qquad ( 17 )$$

The LOF of Equation (17) is an average local reachability density of the neighboring coordinate data points divided by the local reachability density.

An LOF of about 1 indicates that the coordinate data points Xₖ^{p,q} is comparable to the neighboring coordinate data points and is not an outlier. An LOF value less the 1 indicates that the coordinate data points Xₖ^{p,q} is part of a dense region of coordinate data points (i.e., coordinate data points are close together). An LOF value that is significantly larger than 1 indicates that the coordinate data points Xₖ^{p,q} is an outlier. For example, when the LOF satisfies the following condition:

LOF_{K}(Xₖ^{p,q})≥Th_{LOF}>1 (18)

where Th_{LOF} is a LOF threshold,

The coordinate data points Xₖ^{p,q} is identified as an outlier, triggering an alert and a notification to the systems administrator that point out a trade breach between the two properties p and q at the time tₖ. Examples of LOF threshold values, Th_{LOF}, are 1.5, 1.6, 1.7, 1.8, 1.9, or 2, or Th_{LOF} may be set to a value greater than 2.

In an alternative implementation, density-based spatial clustering of applications with noise may be used to detect outlier data points. Consider the cluster C of coordinate data points. The coordinate data points are classified as core points, density-reachable points, or outliers. All coordinate data points that are not reachable from any other coordinate points are identified as outliers.

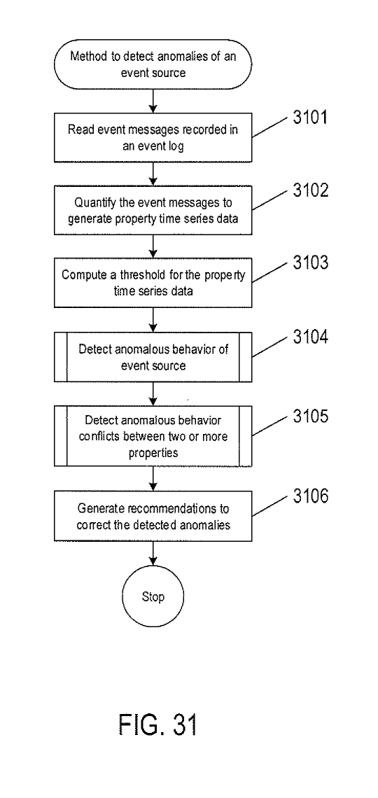

The methods described below with reference to FIGS. 31-36 are stored in one or more data-storage devices as machine-readable instructions that when executed by one or more processors of the computer system shown in FIG. 1 to analyze and detect anomalies of event sources and generate recommendations to correct the anomalies.

FIG. 31 shows a control-flow diagram of an automated method to detect anomalies of an event source. In block 3101, event messages are read from an event log of an event source stored in a data-storage device. In block 3102, the event messages are quantified to generate property time series data, as described above with reference to FIGS. 19-20C. In block 3103, a threshold is computed for the property time series data as described above with reference to FIGS. 21A-24B. In block 3104, a routine “detect anomalous behavior of the event source” is called. In block 3105, a routine “detect anomalous behavior conflicts between two or more properties” is called. In block 3106, recommendations to correct the detected anomalies are generated in response to the detected anomalies in blocks 3104 and 3105.

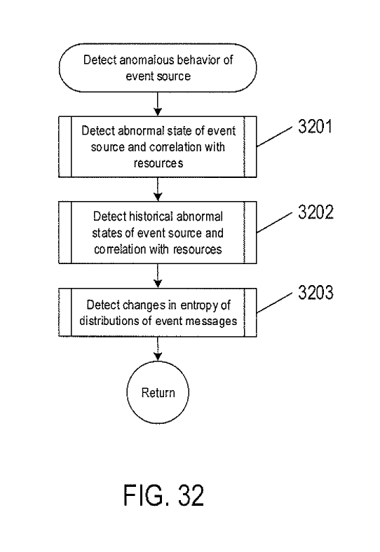

FIG. 32 shows a control-flow diagram of the routine “detect anomalous behavior of the event source” called in block 3104 of FIG. 31. In block 3201, a routine “detect abnormal state of event source and correlation with resources” is called. In block 3202, a routine “detect historical abnormal states of event source and correlation with resources” is called. In block 3203, a routine “detect changes in entropy of distributions of event messages” is called.

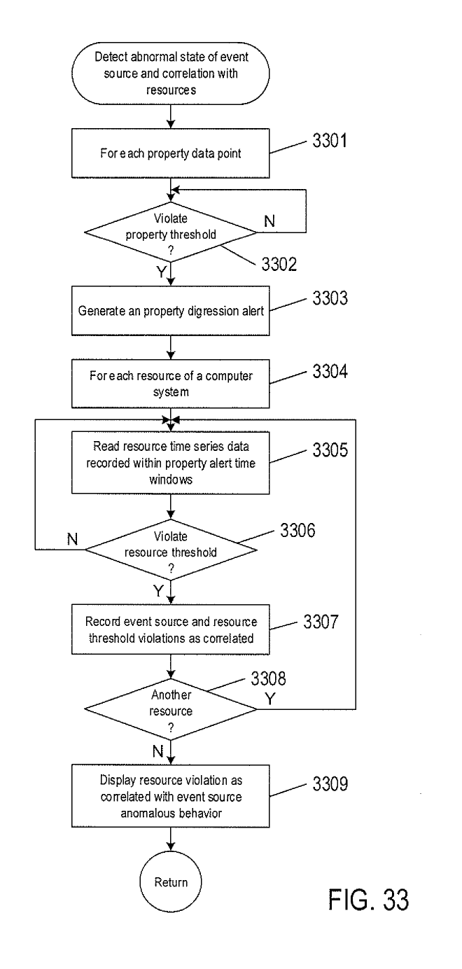

FIG. 33 shows a control-flow diagram of the routine “detect abnormal state of event source and correlation with resources” called in block 3201 of FIG. 32. A loop beginning with block 3301 repeats the computational operations of block 3302 for each property data point in the property time series data. In decision block 3302, when a property data point violates a corresponding threshold, control flows to block 3303 in which a property digression alert is generated and displayed on an administration console. A loop beginning with block 3304, repeats the computational operations of blocks 3305-3308 for each resource of a computer system. In block 3305, resource time series data recorded within a property alert time window of the property digression alert is read. In decision block 3306, if a threshold of the resource is violated within the property alert time window, control flows to block 3307. In block 3307, the event source and resource threshold violations are recorded as correlated. In decision block 3308, when the resources of the computer system have been considered, control flows to block 3309. In block 3309, correlated anomalous behavior of the resource threshold violations and the property digression alerts are displayed on the administration console.

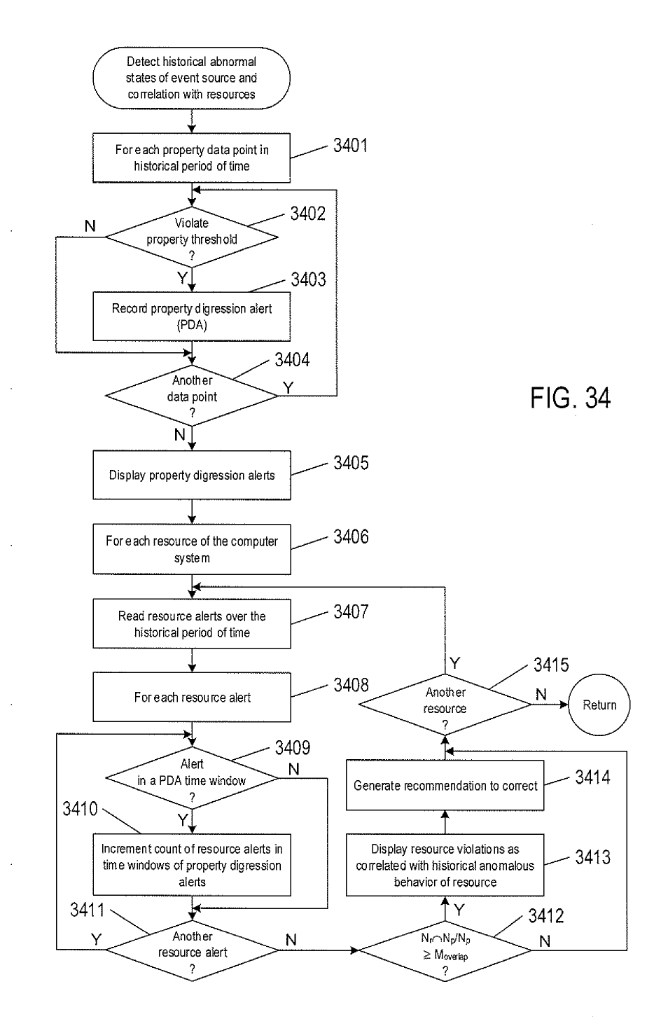

FIG. 34 shows a control-flow diagram of the routine “detect historical abnormal states of event source and correlation with resources” called in block 3202 of FIG. 33. A loop beginning with block 3401 repeats the computational operations represented by blocks 3402-3404 for each property data point of property time series data recorded over a period of time. In decision block 3402, when a property data point violates threshold, control flows to block 3403. In block 3403, a property digression alert is recorded in data-storage device. In decision block 3404, when the property data points of the property time series data have been considered, control flows to block 3405. In block 3405, the property digression alerts recorded in block 3403 are displayed on a systems administration console. A loop beginning with block 3406, repeats the computational operations represented by blocks 3407-3415 for each resource of the computer system that runs the event source. In block 3407, resource alerts for the resource recorded during the time period are determined from reading stored recorded resource time series data for the resource. A loop beginning with block 3408 repeats the computational operations represented by blocks 3409-3411 for each resource alert. In block 3409, when a resource alert occurred within a time window of a property digression alert, control flows to block 3410. In block 3410, a count, Nᵣ∩Nₚ, of resource alerts occurring time windows of the property digression alerts is incremented. In decision block 3411, when the resource alerts for the resource have been considered, control flows to decision block 3412. In decision block 3412, when the fraction of intersecting threshold violations by the resource and the event source is greater than a minimum correlation of intersecting threshold violations, as described above with reference to Equation (9), control flows to block 3413. In block 3414, a recommendation to correct the correlated anomalous behavior of the event source and the resource may be generated. In decision block 3415, control flows to block 3407 for another resource of the computer system.

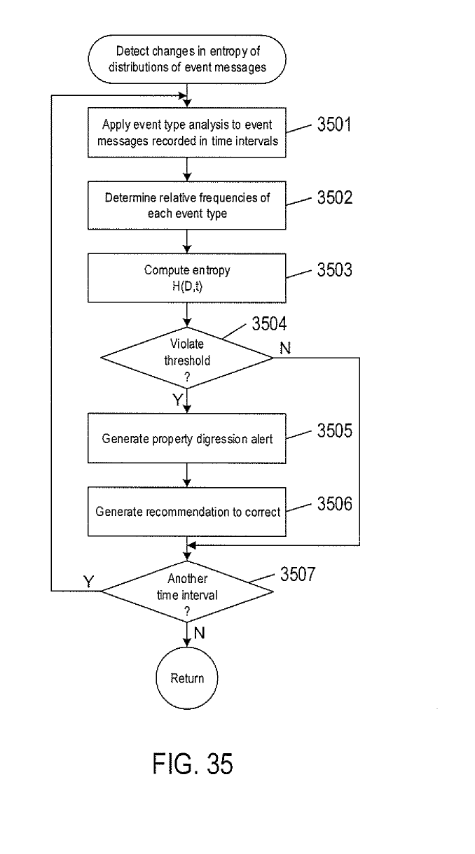

FIG. 35 shows a control-flow diagram of the routine “detect changes in entropy of distributions of event messages” called in block 3203 of FIG. 32. In block 3501, apply event type analysis to events recorded in separate time intervals as described above with reference to FIG. 28. In block 3502, relative frequencies of event types recorded in each of the time intervals are computed to determine a distributed of event types in each time interval, as described above with reference to Equation (10) and FIG. 28. In block 3503, an entropy is computed for the distribution of event types in each of the time intervals, as described above with reference to Equation (11) and FIG. 29. In decision block 3504, when an entropy violates an entropy threshold, control flows to block 3505. In block 3505, a property digression alert indicate anomalous behavior of the event source is displayed. In block 3506, a recommendation to correct the anomalous behavior is displayed.

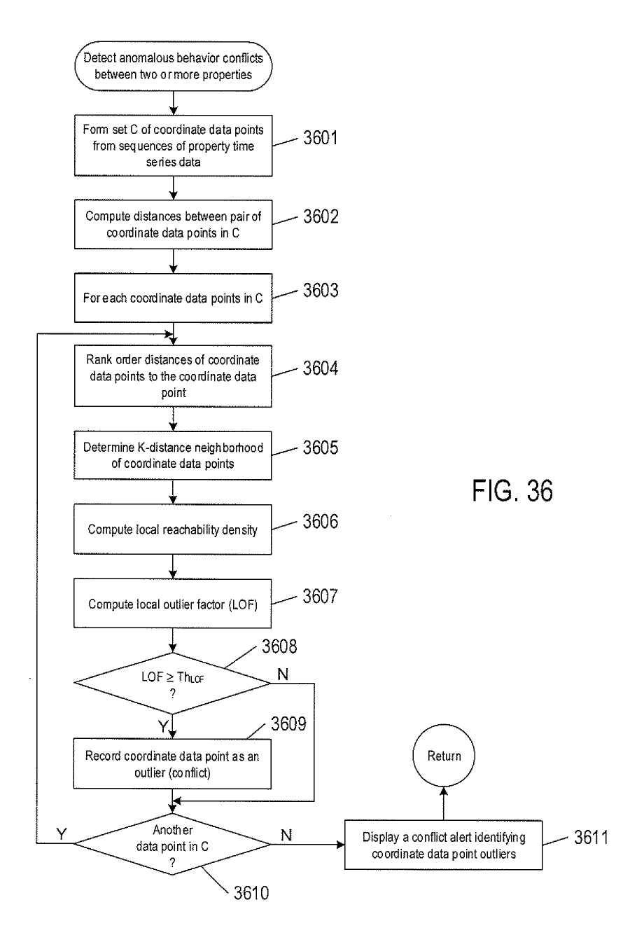

FIG. 36 shows a control-flow diagram of the routine “detect anomalous behavior conflicts between two or more properties” called in block 3105 of FIG. 31. In block 3601, a cluster of coordinate data points are formed from two or more sequences of property time series data. In block 3602, distances are computed between each pair of coordinates data points in the cluster. A loop beginning with block 3603 repeats the operations represented by blocks 3604-3610 for each coordinate data point in the cluster. In block 3604, a K-th nearest neighbor distance are rank ordered. In block 3605, a K-distance neighborhood coordinate data points are computed for the coordinate data point, as described above with reference to Equation (14). In block 3606, a local reachability density is computed for the coordinate point, as described above with reference to Equation (15). In block 3607, an LOF is computed for the coordinate data point, as described above with reference to Equation (17). In decision block 3208, when the LOF computed in block 3607 is greater than an LOF threshold as described above with reference to Equation (18) control flows to block 3609 where the coordinate data point is identified as an outlier. In decision block 3610, the operations represented by blocks 3604-3609 are repeated for another coordinate point in the cluster. In block 3611, an anomalous behavior conflict is displayed identifying the coordinate points outliers.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated method stored in one or more data-storage devices and executed using one or more processors of a management server computer of a distributed computing system to detect anomalous behavior of an event source from event messages generated by the event source, the method comprising:
quantifying the event messages to generate property time series data, the property time series data representing a property of the event source;
computing a threshold from the property time series data generated over time, the threshold representing a normalcy bound for normal operation of the event source;
detecting an abnormal state of the event source based on one or more property data points of the property time series data that violate the threshold, the abnormal state indicating anomalous behavior by the event source;
displaying a property digression alert on a system console, the property digression alert indicating anomalous behavior of the event source; and
generating a recommendation to correct the anomalous behavior of the event source.

2. The method of claim 1 wherein quantifying the event messages to generate property time series data comprises:
determining a volume of event messages recorded in the event log within each time interval of a series of adjacent time intervals;
determining a velocity of event messages based on the volumes of event messages within each time interval of the series of adjacent time intervals;
determining an acceleration of event messages based on the velocities of event messages within each time interval of the series of adjacent time intervals; and
determining a variety of event messages within each time interval of the series of adjacent time intervals.

3. The method of claim 1 wherein detecting the abnormal state of the event source comprises for each property data point of the property time series data, generating a property digression alert when the property data point violates the threshold.

4. The method of claim 4 further comprises:
for each resource of a computer system that runs the event source, reading resource time series data generated within a property alert time window centered at a time of the property digression alert; and
displaying an alert that the resource is correlated with the anomalous behavior of the event source, when the resource violates an associated threshold within the property alert time window.

5. The method of claim 1 wherein detecting the abnormal state of the event source comprises:
for each property data point of the property time series data recorded over a period time, recording a property digression alert that corresponds to when the property data point violated the threshold within the period of time; and
displaying each property digression alert on the system console.

6. The method of claim 5 further comprises:
for each resource of a computer system that runs the event source,
reading resource time series data recorded over the period of time in a data-storage device;
determining threshold violations of the resource time series data over the period of time;
counting resource violations that occur within time windows of the property digression alerts; and
displaying an alert on the system console that the resource is correlated with historical anomalous behavior of the event source, when the count of resource violations that occur within the time windows of the property digression alerts is greater than a minimum correlation.

7. The method of claim 1 wherein detecting the abnormal state of the event source comprises:
determining event type distributions of the event messages within a series of time intervals;
computing an entropy for each event type distribution associated with each time interval;
displaying an alert on the system console when the entropy violates an entropy threshold; and
displaying a recommendation to move the workload of the event source to a different computer system with a minimum standard deviation of entropies of event sources that run on the computer system.

8. The method of claim 1 further comprising:
computing a distance between each pair of coordinate data points in a cluster of coordinate data points formed from two or more sequence of property time series data;
computing a nearest neighbor distance for each coordinate data point;
determining a distance neighborhood for each coordinate data point of the cluster based on the nearest neighbor distance of each coordinate data point;
computing a local reachability density for each coordinate data point based on the distance neighborhood of each coordinate data point;
computing a local outlier factor for each coordinate data point based on the local reachability density of coordinate data point within the distance neighborhood; and
identifying a coordinate data point in the cluster as outlier when the local outlier factor of is greater than the local outlier factor threshold.

9. A system to detect anomalous behavior of an event source from event messages generated by the event source, the system comprising:
one or more processors;
one or more data-storage devices; and
machine-readable instructions stored in the one or more data-storage devices that when executed using the one or more processors controls the system to carry out
quantifying the event messages to generate property time series data, the property time series data representing a property of the event source;
computing a threshold from the property time series data generated over time, the threshold representing a normalcy bound for normal operation of the event source;
detecting an abnormal state of the event source based on one or more property data points of the property time series data that violate the threshold, the abnormal state indicating anomalous behavior by the event source;
displaying a property digression alert on a system console, the property digression alert indicating anomalous behavior of the event source; and
generating a recommendation to correct the anomalous behavior of the event source.

10. The system of claim 9 wherein quantifying the event messages to generate property time series data comprises:
determining a volume of event messages recorded in the event log within each time interval of a series of adjacent time intervals;
determining a velocity of event messages based on the volumes of event messages within each time interval of the series of adjacent time intervals;
determining an acceleration of event messages based on the velocities of event messages within each time interval of the series of adjacent time intervals; and
determining a variety of event messages within each time interval of the series of adjacent time intervals.

11. The system of claim 9 wherein detecting the abnormal state of the event source comprises for each property data point of the property time series data, generating a property digression alert when the property data point violates the threshold.

12. The system of claim 11 further comprises:
for each resource of a computer system that runs the event source, reading resource time series data generated within a property alert time window centered at a time of the property digression alert; and
displaying an alert that the resource is correlated with the anomalous behavior of the event source, when the resource violates an associated threshold within the property alert time window.

13. The system of claim 9 wherein detecting the abnormal state of the event source comprises:
for each property data point of the property time series data recorded over a period time, recording a property digression alert that corresponds to when the property data point violated the threshold within the period of time; and
displaying each property digression alert on the system console.

14. The system of claim 13 further comprises:
for each resource of a computer system that runs the event source,
reading resource time series data recorded over the period of time in a data-storage device;
determining threshold violations of the resource time series data over the period of time;
counting resource violations that occur within time windows of the property digression alerts; and
displaying an alert on the system console that the resource is correlated with historical anomalous behavior of the event source, when the count of resource violations that occur within the time windows of the property digression alerts is greater than a minimum correlation.

15. The system of claim 9 wherein detecting the abnormal state of the event source comprises:
determining event type distributions of the event messages within a series of time intervals;
computing an entropy for each event type distribution associated with each time interval;
displaying an alert on the system console when the entropy violates an entropy threshold; and
displaying a recommendation to move the workload of the event source to a different computer system with a minimum standard deviation of entropies of event sources that run on the computer system.

16. The system of claim 9 further comprising:
computing a distance between each pair of coordinate data points in a cluster of coordinate data points formed from two or more sequence of property time series data;
computing a nearest neighbor distance for each coordinate data point;
determining a distance neighborhood for each coordinate data point of the cluster based on the nearest neighbor distance of each coordinate data point;
computing a local reachability density for each coordinate data point based on the distance neighborhood of each coordinate data point;
computing a local outlier factor for each coordinate data point based on the local reachability density of coordinate data point within the distance neighborhood; and
identifying a coordinate data point in the cluster as outlier when the local outlier factor of is greater than the local outlier factor threshold.

17. A non-transitory computer-readable medium encoded with machine-readable instructions that implement a method carried out by one or more processors of a computer system to perform the operations of
quantifying the event messages to generate property time series data, the property time series data representing a property of the event source;
computing a threshold from the property time series data generated over time, the threshold representing a normalcy bound for normal operation of the event source;
detecting an abnormal state of the event source based on one or more property data points of the property time series data that violate the threshold, the abnormal state indicating anomalous behavior by the event source;
displaying a property digression alert on a system console, the property digression alert indicating anomalous behavior of the event source; and
generating a recommendation to correct the anomalous behavior of the event source.

18. The medium of claim 17 wherein quantifying the event messages to generate property time series data comprises:
determining a volume of event messages recorded in the event log within each time interval of a series of adjacent time intervals;
determining a velocity of event messages based on the volumes of event messages within each time interval of the series of adjacent time intervals;
determining an acceleration of event messages based on the velocities of event messages within each time interval of the series of adjacent time intervals; and
determining a variety of event messages within each time interval of the series of adjacent time intervals.

19. The medium of claim 17 wherein detecting the abnormal state of the event source comprises for each property data point of the property time series data, generating a property digression alert when the property data point violates the threshold.

20. The medium of claim 19 further comprises:
for each resource of a computer system that runs the event source, reading resource time series data generated within a property alert time window centered at a time of the property digression alert; and
displaying an alert that the resource is correlated with the anomalous behavior of the event source, when the resource violates an associated threshold within the property alert time window.

21. The medium of claim 17 wherein detecting the abnormal state of the event source comprises:
for each property data point of the property time series data recorded over a period time, recording a property digression alert that corresponds to when the property data point violated the threshold within the period of time; and
displaying each property digression alert on the system console.

22. The medium of claim 21 further comprises:
for each resource of a computer system that runs the event source,
reading resource time series data recorded over the period of time in a data-storage device;
determining threshold violations of the resource time series data over the period of time;
counting resource violations that occur within time windows of the property digression alerts; and
displaying an alert on the system console that the resource is correlated with historical anomalous behavior of the event source, when the count of resource violations that occur within the time windows of the property digression alerts is greater than a minimum correlation.

23. The medium of claim 17 wherein detecting the abnormal state of the event source comprises:
determining event type distributions of the event messages within a series of time intervals;
computing an entropy for each event type distribution associated with each time interval;
displaying an alert on the system console when the entropy violates an entropy threshold; and
displaying a recommendation to move the workload of the event source to a different computer system with a minimum standard deviation of entropies of event sources that run on the computer system.

24. The medium of claim 17 further comprising:
computing a distance between each pair of coordinate data points in a cluster of coordinate data points formed from two or more sequence of property time series data;
computing a nearest neighbor distance for each coordinate data point;
determining a distance neighborhood for each coordinate data point of the cluster based on the nearest neighbor distance of each coordinate data point;
computing a local reachability density for each coordinate data point based on the distance neighborhood of each coordinate data point;
computing a local outlier factor for each coordinate data point based on the local reachability density of coordinate data point within the distance neighborhood; and
identifying a coordinate data point in the cluster as outlier when the local outlier factor of is greater than the local outlier factor threshold.
